(19) United States
(12) Patent Application Publication
(10) Pub. No.: US 2009/0192731 A1
(43) Pub. Date: Jul. 30, 2009

(54) System and Method for Monitoring a Health State of Hydrocarbon Production Equipment

(75) Inventors: Orlando De Jesus, Frisco, TX (US); Syed Hamid, Dallas, TX (US); Pete Dagenais, The Colony, TX (US); Stephen Tilghman, Marlow, OK (US); Michael Fripp, Carrollton, TX (US); Patrick Collet, Duncan, OK (US)

Correspondence Address: JOHN W. WUSTENBERG, P.O. BOX 1431, DUNCAN, OK, 73536, US

(73) Assignee: HALLIBURTON ENERGY SERVICES, INC., Houston, TX (US)

(21) Appl. No.: 12/019,284

(22) Filed: Jan. 24, 2008

(51) Int. Cl. G01L 1/00; G06F 19/00

(52) U.S. Cl. 702/42; 702/81

(57) ABSTRACT

A device for monitoring the health state of hydrocarbon production equipment is disclosed. The device has a plurality of targets, which are associated with the hydrocarbon production equipment. A record of the initial target positions and/or dimensions relative to the hydrocarbon production equipment is created. A sensor that is compatible with the targets is used to observe the targets and produce a sensor output. An analysis device uses the record of the initial positions, dimensions and the sensor output to determine one or more health state parameters, which may be used to determine the health state of the hydrocarbon production equipment.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD

The apparatus and methods disclosed herein relate to structural monitoring techniques and equipment. More particularly, this disclosure concerns the use of target identifiers to determine structural and material properties of hydrocarbon production equipment, and the use of these properties to determine a health state of the hydrocarbon production equipment.

### BACKGROUND

Hydrocarbon production equipment is used in a variety of production activities, such as exploration, drilling, completion activities, well servicing, workover operations, and production of oil and gas from hydrocarbon bearing reservoirs. A common example of hydrocarbon production equipment includes coiled tubing, which is useful for a variety of oilfield operations. During a workover, coiled tubing is run in and out of a wellbore through an injector. The injector straightens the coiled tubing for injection into the hole and subsequently reshapes the coiled tubing upon extraction for placement back on the coiled tubing spool. During use, coiled tubing may also experience a rotational force due to drilling or uncoiling of the tubing from the spool during injection. This continuous process may introduce structural changes and fatigue in the coiled tubing after repeated operations, potentially creating failure points or cracks in the coiled tubing.

During operation, the coiled tubing may experience varying loads depending on the type of tools attached to the tubing and operations performed. Additional stresses and strains may be introduced through the varying temperatures experienced in the wellbore and the varying pressures passed through the tubing. These stresses and strains may alter the overall length of the coiled tubing during its useful life, requiring the operator to introduce a depth correction during use. The stresses and strains may also contribute to the overall fatigue of the coiled tubing.

Other oilfield equipment may experience similar wear and fatigue through use. For example, jointed tubing may experience the same stresses and strains as coiled tubing, since it may generally be used for the same types of operations. Other production equipment such as wirelines, slicklines, and packers may also experience fatigue due to similar operations and continued use. The wear and fatigue may eventually result in the equipment being discarded.

### SUMMARY

Disclosed herein is an apparatus for monitoring the health state of hydrocarbon production equipment. The apparatus comprises a one or more (e.g., a plurality) targets that are associated with the hydrocarbon production equipment. In an embodiment, the targets may be 2D barcode or matrix symbols. A record indicating a baseline state of the one or more targets associated with the hydrocarbon production equipment may be created. A sensor capable of observing the targets may be used to produce an output. The sensor is compatible with the one or more targets and produces a sensor output comprising a current state of the one or more targets. In an embodiment, a second sensor may be used to observe additional properties of the hydrocarbon production equipment. An analysis device receives the record and the sensor output(s), compares the baseline state of the target to the current state of the target, and produces one or more health state parameters associated with the hydrocarbon production equipment.

Also disclosed herein is a method for determining the health state of hydrocarbon production equipment. The method involves associating one or more (e.g., a plurality) targets with the hydrocarbon production equipment. Baseline states of the one or more targets are then recorded. The targets are observed using a sensor that is compatible with the targets and a sensor output comprising a current state of the targets is created. In an embodiment, a second sensor may be used to observe additional properties of the hydrocarbon production equipment. One or more health state parameters are then determined by comparing the sensor output(s) comprising the current state of the one or more targets to the record data comprising the baseline state of the one or more targets. In an embodiment, the health state parameters may be used to predict a failure point for the hydrocarbon production equipment.

In another embodiment of the apparatus disclosed herein is a device for monitoring the health state of production conduit. The apparatus comprises a plurality of targets associated with the production conduit. In an embodiment, the targets may be 2D barcode or matrix symbols. A record of the initial positions and/or dimensions of the targets associated with the production conduit may be created. A sensor capable of observing the targets associated with the production conduit may observe the targets and produce a sensor output. An analysis device for utilizing the record of the baseline target positions and/or dimensions and the sensor output may be present to determine one or more health state parameters. In an embodiment, the health state parameters may be used to determine the suitability of the production conduit for use in an oilfield operation. The one or more health state parameters may be selected from the group consisting of: a set of dimensions of a target, a longitudinal position of a target, a rotational position of a target, a position indication of two or more targets, a localized stress reading near one or more targets, a stress reading for the production conduit, a localized strain measurement near one or more targets, an overall strain measurement for the production conduit, a localized fatigue measurement near one or more targets, an overall fatigue measurement for the production conduit, an elongation measurement of the production conduit, the degree of ovality for cylindrical production conduit, the curvature of a surface of the production conduit, the flexural strength of the production conduit, a localized flexural strength near one or more targets, and a combination thereof. The targets may be of a type selected from the group consisting of: 1D barcode symbols, 2D barcode symbols, 3D barcode symbol, identified surface markings, identified subsurface markings, generated subsurface markings, a symbol capable of defining a Symbolic Strain Rosette (“SSR”), and a combination thereof. The targets may be placed at regular intervals along the production conduit. The sensor may comprise one or more of a camera, a machine vision system, and a portion of a machine vision system. The one or more health state parameters may produce a prediction of an approaching failure point for the production conduit or a section of the production conduit. The apparatus may further comprise a second sensor capable of determining one or more of a length along the production conduit, a load carried by the production conduit, a relative radial position of the sensor with respect to the production conduit, a relative longitudinal position of the sensor with respect to the production conduit, a rate of movement of the sensor, and a rate of movement of the production conduit.

In yet another embodiment, a method is disclosed for monitoring the health state of production conduit and transmission equipment. In an embodiment, the production conduit may be coiled tubing, wellbore casing, jointed tubing, production tubing, drill pipe, or fracturing tubing, and the transmission equipment may be wireline or slickline. The method includes associating a plurality of targets with production conduit, transmission equipment, or both. The initial positions and/or dimensions of the targets may be recorded to create baseline target record. The targets may then be observed with a sensor that is compatible with the targets and produces a sensor output. An analysis device may produce one or more health state parameters from the sensor output and the baseline target record. The plurality of targets may be associated with one or more of the production conduit and the transmission conduit in an approximately linear pattern or an approximately spiral pattern. The one or more health state parameters may comprise one or more of a longitudinal position of a target, a rotational position of a target, a position indication of two or more targets, a localized stress reading near one or more targets, a stress reading for the one or more of production conduit and transmission equipment, a localized strain measurement near one or more targets, an overall strain measurement for the one or more of production conduit and transmission equipment, a localized fatigue measurement near one or more targets, an overall fatigue measurement for the one or more of production conduit and transmission equipment, an elongation measurement of the one or more of production conduit and transmission equipment, the degree of ovality for cylindrical production conduit, the degree of ovality for cylindrical transmission equipment, the flexural strength of the one or more of production conduit and transmission equipment, a localized flexural strength near one or more targets, and the curvature of a surface of the one or more of production conduit and transmission equipment. The plurality of targets may be of a type selected from the group consisting of: 1D barcode symbols, 2D barcode symbols, 3D barcode symbol, identified surface markings, identified subsurface markings, generated subsurface markings, a symbol capable of defining a Symbolic Strain Rosette (“SSR”), and a combination thereof. The baseline position and/or dimension record may be recorded in the data contained in the targets, wherein the plurality of targets comprise one or more of a 1D barcode, a 2D barcode, and a 3D barcode symbol. The sensor may be of a type selected from the group consisting of: a camera, a machine vision system, a component of a machine vision system, and a combination thereof. The method may further comprise observing the targets with a second sensor capable of determining one or more of a length along the production conduit, a load carried by the production conduit, a relative radial position of the sensor with respect to the production conduit, a relative longitudinal position of the sensor with respect to the production conduit, a rate of movement of the sensor, and a rate of movement of the production conduit.

The present disclosure also describes a method for monitoring the integrity of a production conduit or a hydrocarbon tool connection. The method includes associating a plurality of targets with a production conduit, a hydrocarbon tool, or both. A baseline record of the initial and/or historical target positions and/or dimensions may then be created. A connection may then be formed using the production conduit, the hydrocarbon tool, or both. In an embodiment, any connection combination may be created. The connection may then be pressurized. The targets may be observed with a sensor while the connection is pressurized to produce a sensor output. A health state parameter may then be determined based on the baseline and actual record of the plurality of targets and the sensor output. In an embodiment, the health state parameters may be used to determine if a seal is defective in the connection. The production conduit may comprise one or more of coiled tubing, wellbore casing, jointed tubing, production tubing, drill pipe, fracturing tubing, and combinations thereof. The connection may be one or more of a pin and box type connection, a threaded connection, and a coupling type connection. The connection may be pressurized between a maximum and minimum specified operating pressure (e.g., 5000 to 20,000 psi).

Also disclosed herein is an apparatus for monitoring the health state of transmission equipment. The apparatus may include a plurality of targets associated with the transmission equipment. The targets may be placed at regular intervals along the transmission equipment. A baseline record may be used to indicate the initial and/or historical position and/or dimension of the plurality of targets associated with the transmission equipment. A sensor may be used to observe the plurality of targets over time to produce a sensor output. An analysis device may use the sensor output and the baseline record of positions and/or dimensions to determine one or more health state parameters. The health state parameters may be used to predict an approaching failure point for the transmission equipment or a section of the transmission equipment. The one or more health state parameters may comprise one or more of a position indication of two or more targets, a localized stress reading near one or more targets, a stress reading for the one or more of a production conduit and hydrocarbon tool, a localized strain measurement near one or more targets, an overall strain measurement for the one or more of a production conduit and hydrocarbon tool, and the curvature of a surface of the one or more of a production conduit and hydrocarbon tool. In an embodiment, an optional second sensor may also be used to determine one or more additional properties of the transmission equipment. The second sensor may determine one or more of a length along the transmission equipment, a load carried by the transmission equipment, a relative longitudinal position of the sensor with respect to the transmission equipment, a rate of movement of the sensor, and a rate of movement of the transmission equipment.

In still another embodiment, an apparatus is disclosed for monitoring the health state of hydrocarbon tools. The apparatus may include a plurality of targets associated with a hydrocarbon tool. In an embodiment, the targets may be associated with the hydrocarbon tool in a location that is known to be subject to hydraulic pressure, mechanical force, or both. A baseline record may indicate the initial and/or historical positions and/or dimensions of the plurality of targets. A sensor may then observe the plurality of targets over the life of the equipment to produce a sensor output. In an embodiment, the hydrocarbon tool may require disassembly, for example during redressing of the tool, prior to observing the plurality of targets. An analysis device may be used to determine one or more health state parameters from the sensor output and the record of the baseline positions and/or dimensions. The one or more health state parameters may be selected from the group consisting of: a longitudinal position of a target, a position indication of two or more targets, a localized stress reading near one or more targets, a stress reading for the hydrocarbon tool, a localized strain measurement near one or more targets, an overall strain measurement for the hydrocarbon tool, a localized fatigue measurement near one or more targets, an overall fatigue measurement for the hydrocarbon tool, the degree of ovality for cylindrical hydrocarbon tool, the curvature of a surface of the hydrocarbon tool, and a combination thereof. The one or more health state parameters may produce a prediction of an approaching failure point for the hydrocarbon tool or a component of the hydrocarbon tool.

A method is disclosed for measuring the torque on hydrocarbon production equipment connections. The method may include the association of a plurality of targets with one or more production conduits or hydrocarbon tools. A baseline record of the initial and/or historical target positions and/or dimensions may be created. A connection may then be formed between the production conduits, hydrocarbon tools, or both. A torque is then applied to the connection in order to form the complete the connection. The targets may be observed with a sensor during or after the application of torque to the connection to produce a sensor output. One or more health state parameters may be determined from the sensor output and the baseline record of the positions and/or dimensions of the targets. In an embodiment, the health state parameter is the torque measurement for the connection. The connection may be one or more of a pin and box type connection, a threaded connection, and a coupling type connection. The one or more health state parameters may comprise one or more of a position indication of two or more targets, a localized stress reading near one or more targets, a stress reading for the one or more of a production conduit and hydrocarbon tool, a localized strain measurement near one or more targets, an overall strain measurement for the one or more of a production conduit and hydrocarbon tool, and a torque measurement for the connection.

Also disclosed herein is a method for monitoring the health state of hydrocarbon tools. The method may include the association of a plurality of targets with a hydrocarbon tool and a baseline record of the targets' initial and/or historical positions and/or dimensions. In an embodiment, the hydrocarbon tool may be any type of tool such as a zonal isolation device, a packer, a bridge plug, a logging tool, a drilling tool, a pump, a pump housing, a manifold, a motor, a pressure test fixture, or any combination thereof. The targets may be observed using a sensor to produce a sensor output. In an embodiment, the observation may occur before, during, or after use of the hydrocarbon tool. In an embodiment, the targets are observed with the sensor after disassembly of the hydrocarbon tool. One or more health state parameters may be determined from the sensor output and the baseline record of the positions and/or dimensions of the targets.

In another embodiment, a method for monitoring the health state of hydrocarbon production equipment attachment points is disclosed. The method may include associating a plurality of targets with a hydrocarbon production equipment attachment point. In an embodiment, the hydrocarbon production equipment attachment point may be any type of equipment used to support a hydrocarbon tool such as a mounting bracket. The initial positions and/or dimensions of the targets may then be recorded. The targets may then be observed to produce a sensor output. In an embodiment, the targets may be observed during use of the equipment the connection point supports. One or more health state parameters may then be determined using the sensor output and the record of the initial, historical and actual target positions and/or dimensions. In an embodiment an approaching failure point may be predicted for the connection point or a section of the connection point based on the health state parameters.

### BRIEF DESCRIPTION OF THE DRAWINGS

FIG. 1 is a diagrammatic representation of an apparatus for determining the health state parameters of hydrocarbon production equipment.

FIG. 2 is an illustration of an embodiment of a 2D barcode and a Symbolic Strain Rosette.

FIG. 3A is an illustration of an example pattern of targets associated with hydrocarbon production equipment.

FIG. 3B is an alternative illustration of an example pattern of targets associated with hydrocarbon production equipment.

FIG. 3C is another alternative illustration of an example pattern of targets associated with hydrocarbon production equipment.

FIG. 4 is a diagrammatic representation of an embodiment of a sensor.

FIG. 5 is a flowchart illustrating an embodiment of a method for determining the health state parameters of hydrocarbon production equipment.

FIG. 6 is an illustration of an example of a coiled tubing unit.

FIG. 7 is an illustration of an example of a hydrocarbon production equipment connection.

FIG. 8 is another illustration of an example of a hydrocarbon production equipment connection.

FIG. 9 is a flowchart illustrating an embodiment of a method for monitoring the health state of production conduit and hydrocarbon tools.

FIG. 10 illustrates an embodiment of an apparatus for determining the torque between segments of hydrocarbon production equipment.

FIG. 11 is a flowchart illustrating an embodiment of a method for measuring the torque between segments of hydrocarbon production equipment.

FIG. 12 is an illustration of an example of a hydrocarbon tool.

FIG. 13 is a flowchart illustrating an embodiment of a method for monitoring the health state of a hydrocarbon tool.

FIG. 14 is an illustration of an example of a hydrocarbon connection point.

FIG. 15 is another illustration of an example of a hydrocarbon connection point.

FIG. 16 illustrates a general purpose computer system suitable for implementing all or a portion of one or more embodiments of the disclosure.

### DETAILED DESCRIPTION

Accurate and safe oilfield operations require monitoring of the hydrocarbon production equipment used during production activities to determine their general suitability for a given operation. A measurement of the fatigue of the system would indicate the general health state of the equipment. Continuous monitoring of the fatigue and other indicators would allow the suitability of the equipment for a production operation to be gauged prior to placing the equipment in operation. Should the health state of the system indicate that the equipment is no longer suitable for its intended use, it may be repaired or discarded prior to any further use. Therefore, it would be desirable to develop a system and method for identifying and monitoring the health state of hydrocarbon production equipment.

As used herein, the phrase “the health state of hydrocarbon production equipment” is intended to indicate the general suitability of the equipment for its intended purpose at a point in time and is measured by one or more health state parameters. The general suitability of the equipment is determined by comparing the measured health state parameters to equipment specifications and thresholds. The specifications and thresholds are specific to the type of equipment being used and the intended application. For example, if a fracturing procedure requires that tubing withstand several thousand pounds per square inch of pressure, then the health state parameters of the hydrocarbon production equipment would need to indicate the ability of the equipment to withstand a pressure above the expected pressure. The specific thresholds and specifications applicable to each type of hydrocarbon production equipment and intended use would be ascertainable to one skilled in the arts.

The health state of hydrocarbon production equipment may also be referred to herein as the health state of the system. The health state of the system may be determined on an overall basis, which takes into consideration the overall suitability of the hydrocarbon production equipment for its intended use, and on a local basis, which considers the ability of a segment or portion of the hydrocarbon production equipment to meet the specifications and thresholds. The health state of the system may be defined by one more health state parameters which may include or may be determined from: the internal dimensions of one or more targets, the longitudinal position of one or more targets, a rotational position of one or more targets, a position indication of two or more targets, a localized stress reading near one or more targets, an overall stress reading for the hydrocarbon production equipment, a localized strain measurement near one or more targets, an overall strain measurement for the hydrocarbon production equipment, a localized fatigue measurement for one or more targets, an overall fatigue measurement for the hydrocarbon production equipment, the degree of ovality for cylindrical hydrocarbon production equipment, the curvature of a surface, the flexural strength of the hydrocarbon production equipment, a localized flexural strength near one or more targets, an elongation measurement for hydrocarbon production equipment or combinations thereof. The health state parameters may be used to track the health state of the hydrocarbon production equipment over time. In an embodiment, the health state of the system may indicate when the hydrocarbon production equipment should be removed from service, when the equipment may fail, where the failure may occur, and the conditions under which the equipment may be safely operated. The health state of the system may also be used to identify and repair any defects in the hydrocarbon production equipment, thus extending its useful service life.

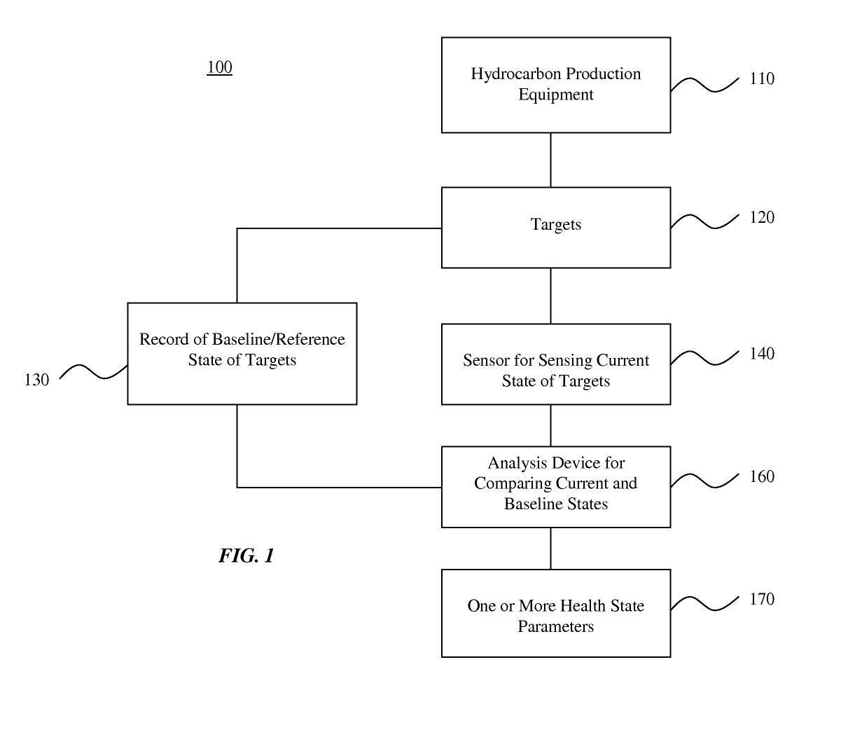

FIG. 1 diagrammatically represents an embodiment of the disclosed apparatus 100 for determining the health state of hydrocarbon production equipment. The system comprises hydrocarbon production equipment 110, a plurality of targets 120 associated with (e.g., disposed directly or indirectly on) the hydrocarbon production equipment, a record 130 indicating the position and/or dimensions for each target 120, a sensor 140 for sensing the targets and creating a sensor output, an analysis device 160 for receiving the record 130 and output from the sensor 140 and analyzing (e.g., comparing) same, and a health state parameter 170 produced by the analysis device.

In an embodiment, the hydrocarbon production equipment 110 may be any production equipment subject to wear or fatigue through continued use, torque, rotation, or other detrimental operating conditions. As used herein, hydrocarbon production equipment refers to equipment used in all phases of hydrocarbon exploration, drilling, completion, production, and abandonment, and the use of the term “production” is not intended to limit the definition to equipment used in production activities. Examples of applicable hydrocarbon production equipment include, without limitation, production conduits, transmission equipment, and hydrocarbon tools. Production conduits may include, among other conduits, oilfield tubulars, coiled tubing, wellbore casing, jointed tubing or pipe segment, production tubing, drill pipe, a work string, and fracturing tubing. Transmission equipment includes equipment used to transport or convey tools, equipment, or signals within a wellbore. Examples of transmission equipment include, without limitation, slickline, and wireline. Hydrocarbon tools include a variety of types of equipment used in the hydrocarbon industry. Hydrocarbon tools are used in all phases of hydrocarbon production from exploration through abandonment. As used herein, hydrocarbon tools refer to both down hole tools, surface tools, subsurface tools, offshore tools, and combinations thereof that are used to support hydrocarbon recovery activities. Examples of hydrocarbon tools include without limitation, packers, bridge plugs, logging tools, drilling tools, fracturing tools, cementing tools, workover tools, pumps, motors, pressure housings, manifolds, storage and mixing vessels, mixers, blenders, and equipment used to transport other tools to the well such a trucks, trailers, skids, barges, etc. The attachment points associated with all of the tools listed herein may be considered to fall within the category of hydrocarbon tools, or it may be considered its own category of hydrocarbon production equipment. Attachment points include but are not limited to flanges, collars, couplings, joints, plates, pin and box connections, threaded connections, and combinations thereof.

In an embodiment shown in FIG. 1, the plurality of targets 120 are associated with the hydrocarbon production equipment. The plurality of targets may comprise any identifiable node or set of nodes. As used herein, a node is an individually identifiable characteristic associated with a target (e.g., an element, bit, or component of a target) and includes within its definition a centroid or other relational position of a group of individually identifiable characteristics. In an embodiment, a target is comprised of a plurality of individually identifiable nodes making up a target pattern or symbol. The targets may be associated with the hydrocarbon production equipment using one or more of removing material from the equipment, adding material to the equipment, or changing the nature of the material in the equipment, as described in more detail herein. For example, the targets may be associated with the hydrocarbon production equipment using one or more of an adhesive, etching, electromagnetic imprinting, painting, direct printing, stamping, and laser-marking.

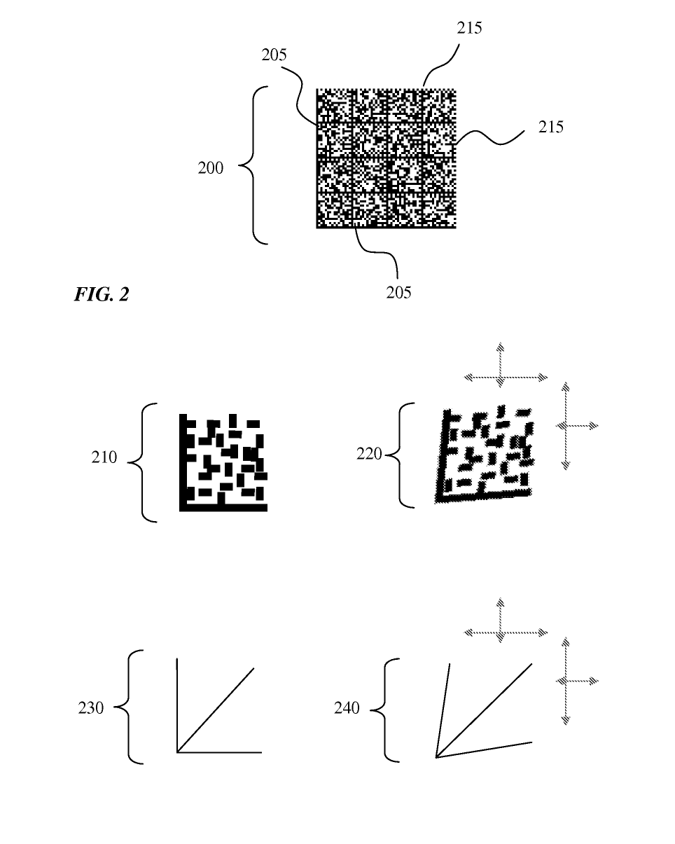

In an embodiment, the targets may individually comprise barcode or barcode like symbols, examples of which are shown in FIG. 2. Examples of these symbols include, without limitation, Data Matrix Symbols (DMS), 1D barcodes, 2D barcodes, 3D barcodes, Bumpy Barcodes, 3-DI symbols, ArrayTag symbols, Aztec Code symbols, Small Aztec Code symbols, Codablock symbols, Code 1 symbols, Code 16K symbols, Code 49 symbols, CP Code symbols, DataGlyphs, Datastrip Code symbols, Dot Code A symbols, HueCode symbols, Intacta.Code symbols, MaxiCode symbols, PDF 417 symbols, Micro PDF417 symbols, QR Code symbols, SmartCode symbols, Snowflake Code symbols, SuperCode symbols, Ultracode symbols, any symbol capable of defining a Symbolic Strain Rosette (“SSR”), and combinations thereof.

A 1D barcode contains a series of black and white bars of varying width used to encode a serial number or other unique identifier. The 1D barcode is vertically redundant, meaning that the same information is repeated vertically and that a portion of the height could be removed without any loss of information.

A 2D barcode stores information along the height as well as the length of the symbol. While some of the vertical redundancy is lost, other techniques have been created to prevent misreads and loss of information. Most 2D barcodes use check words to insure an accurate reading. These barcodes may comprise either a matrix in which the symbol data is based on the position of markings within a matrix or a stacked symbology in which 1D or 2D barcodes are stacked on one another to form a larger barcode array. 2D barcodes are scalable and may be a variety of sizes depending on the barcode symbol used and the size available for application. 2D barcodes may store more than just a single identifier. The increased data storage capacity allows most alphanumeric symbols to be recorded with varying storage capacities depending on the specific 2D barcode symbol chosen. Typical 2D barcodes use lasers to read the black and white patterns containing the data, though some 2D barcodes utilize gray scale or color patterns to encode information.

3D barcodes are similar to a 1D barcode that is embossed or printed on a surface so that a portion of the barcode is raised or is cut on a surface so that a portion of the barcode is carved. The 3D barcode is scanned by distinguishing the difference in heights between the raised and carved portions and the flat portions. 3D barcodes are useful where printed labels cannot be adhered to a surface or otherwise would be destroyed by a hostile or abrasive environment. An example of a 3D barcode is a bumpy barcode symbol. A third dimension may also be enabled for use with the presently disclosed apparatus and method through the use of a 2D barcode placed on a curved surface. The curvature of the surface allows for an additional axis of stress or strain to be calculated when observed by the sensor. In an embodiment, a 2D barcode may be used on hydrocarbon production equipment with a curved surface to determine stress or strain in a third axis. In addition, the use of a 2D barcode on a curved surface could be used to determine the ovality of the surface or equipment, indicating a flattening or change in the curvature of the surface over time. In an embodiment, the 2D barcode may be associated with a curved surface of the hydrocarbon production equipment as if the full curved surface were normal to a surface tangent to the curve. Such target placement would allow the change in the nodes to indicate a change in the curvature of the surface.

A 2D barcode may be used with the apparatus and methods disclosed herein. An example of a 2D barcode is a DMS, an example of which is shown as element 200 in FIG. 2 and a portion of which is depicted as element 210. DMS markings can store between one and five hundred characters in a symbol that is scalable between 1 mil square to 14 inches square. The information in a DMS symbol is encoded by absolute dot position and is less susceptible to printing defects than traditional bar codes. The DMS markings have two adjacent sides printed as solid bars 205, and the remaining sides printed as a series of equally spaced square dots 215. These patterns are useful for both orientation and printing the symbol. The patterns may also be useful for identification of nodes, making them useful as targets and allowing them to be used to define SSRs. The portion of the DMS symbol 210 illustrates that when a DMS symbol 200 is placed under a stress and strain in two dimensions, the marking deforms along with the material it is associated with to form an altered DMS symbol 220. The changes in the DMS symbol may then be used to determine the health state parameters for the hydrocarbon production equipment with which the DMS symbol is associated. The DMS markings may be readable by video cameras, for example a CCD video camera, which in some embodiments may read five symbols per second from a distance of approximately 36 inches.

Other 2D barcodes useful as targets include many commonly used 2D symbologies. 3-DI symbols use small circular symbols that are useful with shiny, curved metal surfaces. ArrayTag symbols are made up of elemental hexagonal symbols that are printed alone or in sequenced groups. ArrayTag symbols can contain hundreds of characters and be read at a distance of fifty meters. Aztec Code symbols are square symbols with a square central bullseye finder. The symbols range in size from between 15 by 15 modules square to 151 by 151 modules, which allows up to 1914 bytes of data. Small Aztec Code is similar to regular Aztec Code but contains less data, allowing the physical dimensions of the symbol to be reduced. Codablock symbols are a stacked symbology containing from 1 to 22 rows of Code 39 symbols, which are discussed in more detail below. Code 1 symbols consist of a pattern of horizontal and vertical bars present in symbols of varying sizes. The symbols may be made into shapes such as an L, U, or T form. Code 16K is a stacked symbology containing from 2 to 16 rows, with 5 ASCII characters per row. Similarly, Code 49 is a stacked symbology containing between two and eight rows and is capable of encoding the complete 128 ASCII character set. CP code symbols comprise square matrices with L-shaped peripheral finder bars, which is visually similar to the DMS markings. DataGlyphs consist of a pattern of small hatch marks encoding binary data. DataGlyphs can be useful as background encoding in logos or tints. Datastrip code symbols consist of very small, rectangular black and white areas capable of containing up to forty eight hundred bytes per square inch. Markers on the side and top of the strip contain alignment information. Dot Code A symbols consist of a square array of dots ranging from six by six up to twelve by twelve allowing for unique patterns within the array. HueCode symbols utilize a series of blocks of cells in which each cell is a shade of gray or color. Identification of the shading determines the data in the cell, which allows between 640 bytes and 40,000 bytes per square inch. MaxiCode is a matrix code made up of a series of interlocking hexagons capable of storing approximately 100 ASCII characters in a one-inch square symbol. A PDF 417 symbol is a stacked symbology with a stop bar group that extends the height of the symbol. A PDF 417 symbol allows for between one to two thousand characters per symbol. A Micro PDF417 symbol is a compact version of PDF 417 symbol and may contain up to 150 bytes, 250 alphanumeric characters, or 366 numeric digits to be stored in the symbol. QR code is a matrix code that results in a square shaped symbol identifiable by the finder pattern of nested alternating dark and light squared at the three corners of the symbol. The symbol has a maximum size of 177 modules, which is capable of holding 7,366 numeric characters or 4,464 alphanumeric characters. SmartCode symbols are made up of a large printed array of binary bits encoding data files. Snowflake code symbols consist of a square array of discrete dots. The Snowflake symbol may encode more than 100 numeric digits and can be applied using a variety of printing techniques. SuperCode symbols use a packet structure allowing for non-rectangular symbol shapes. UltraCode symbols consist of variable-length strips of pixels with non-critical widths. The pixels may be black and white, or may consist of shades of gray or color, allowing for a high data density. Other symbologies in addition to those listed may be suitable for use with the currently disclosed apparatus and methods so long as anode or set of nodes is identifiable within the targets.

In an embodiment as show in FIG. 2, the nodes may be used to identify line segments within the targets that may be useful in the determination of the health state parameters. A SSR is defined in terms of a pattern of three intersecting line segments 230. The length of the line segments is measured by the location of end points defined by nodes identified within the target. For example, four corner markers may be used to identify three line segments consisting of two of the sides of the target and a diagonal line between to the two edge lines. In this example, all three lines may originate from a single point. The lines used for a SSR could be defined by any nodes in a 1D, 2D, or 3D barcode. The SSR utilizes a change in the line length to measure the stress and strain on an object. An example of a SSR under stress and strain 240 in two dimensions is depicted in FIG. 2.

Alternatively, the targets 120 may individually comprise identified surface or subsurface markings. Identified markings may comprise any node or combination of nodes associated with the hydrocarbon production equipment in sufficient number to identify a relational change amongst the nodes. For example, if a SSR were used to identify the health state parameters for the hydrocarbon production equipment, then a plurality of identified markings would be required to identify three lines. The markings may be present on the surface of the production equipment so that they may be identified visually with a sensor. Alternatively, the marking may be a subsurface marking identifiable through the use of a sensor capable of detecting a signal below the surface of the hydrocarbon production equipment. Examples of subsurface markings may include, without limitation, embedded materials or subsurface manufacturing defects. These may be observed through the use of an x-ray scanner, laser, or other sensor capable of penetrating the surface of the equipment, which depends on the nature of the material between the sensor and the target.

In another alternative embodiment, the subsurface markings may be generated. In this embodiment, a series of points or nodes may be generated within the hydrocarbon production equipment such that an identifiable signature remains. An example of a generated subsurface marking may be a magnetic imprint within the hydrocarbon production equipment, an embedded node, or an embedded bar-code like symbol.

In order to determine the health state parameters of the hydrocarbon production system, a reference or baseline state for each or a plurality of targets associated with the hydrocarbon production equipment may be recorded. The record aids in the determination of whether a subsequent change from the reference or baseline conditions of the plurality of targets has occurred. The reference or baseline state may include the dimensions (e.g., x, y, and z lengths), positions, locations, orientations (e.g., x, y, and z coordinates), characteristics, and/or spatial relationship of the targets, the temperature of the hydrocarbon production equipment, the pressure inside the hydrocarbon production equipment and/or other physical condition of the production equipment and associated targets. Unless otherwise specified, reference herein to any one or more of a dimension, position, location, characteristic, orientation, or spatial relationship of a target and/or node, equipment temperature, pressure and/or other physical condition should be understood to include any plurality and/or combinations thereof. For example, a reference or baseline state for a plurality of targets on hydrocarbon production equipment may relate to the dimensions, positions, locations, orientations, characteristics, and/or spatial relationship of the targets, equipment temperature, pressure and/or other physical condition (i) as initially or originally placed on new equipment that has not been previously used in a wellbore servicing activity (i.e., original equipment manufacture (OEM))—also referred to as an OEM record; (ii) as initially or originally placed on hydrocarbon production equipment that has been previously used in wellbore servicing activities and is subsequently retrofitted with targets—also referred to as a retrofit record; (iii) as sensed or measured at one or more times subsequent to the initial/original placement on OEM or retrofitted hydrocarbon production equipment and after such equipment has been used in one or more wellbore servicing activities, for example a plurality of target data and physical measurements associated with historical use of the hydrocarbon production equipment—also referred to as a historical record; or (iv) combinations thereof. In an embodiment, a state of one or more target may comprise a set of dimensions of the target, a longitudinal position of the target, an axial position of the target, a rotational position of the target, equipment temperature, pressure and/or other physical condition or combinations thereof. The use of an OEM record, a retrofit record, a historical record, or a combination thereof allows the cumulative health state of the system to be determined. The reference or baseline state is usually taken to be an undeformed configuration resulting from a zero load state, but it may be any configuration so long as it is previously determined. Furthermore, the reference or baseline state may refer to any state measured and/or recorded prior to a current or instant state. As described in more detail herein, the health state parameters may be determined by analyzing a change in the dimensions, positions, locations, orientations, characteristics, and/or spatial relationship of the targets and/or nodes when comparing sensed data associated with a current or instant state to recorded data for a reference or baseline state.

In an embodiment, the record is stored in a memory or other data storage device, which may be internal or external to one or more system components described herein. For example, the record may be contained in a database stored in an internal or external computer, memory chip, hard drive, storage disk or tape, or other suitable storage device. In an embodiment, the record is stored in a storage device associated with the hydrocarbon production equipment 110 (e.g., a computer associated with the equipment), a storage device associated with the sensor 140, a storage device associated with the analysis device 160, or combinations thereof. Alternatively, the record of the position and/or dimension of the targets may be contained within the symbology of the individual targets themselves. For example, in an embodiment in which an individual target is a bar-code or a bar-code like symbol, the target may contain information within the symbol or matrix. The information may be any information that is capable of being encoded within the data limits of the symbol, including information necessary for determining a health state parameter for the hydrocarbon production equipment. Examples of the type of information capable of being encoded within the target include, without limitation, baseline dimensions and/or positions of the target in relation to the hydrocarbon production equipment, a serial code or unique identifier for the target, a serial code or unique identifier for the hydrocarbon production equipment, a rotational position of the target in relation to a reference point on the hydrocarbon production equipment or combinations thereof. For example, an individual target may contain its initial placement distance from the end of the hydrocarbon production equipment. Alternatively, a serial code or other unique identifier may be contained within each individual target for correlation with a record of the positions and/or dimensions associated with the target.

The targets are associated with the hydrocarbon production equipment such that a deformation of the equipment creates a corresponding deformation of the target. In an embodiment, any means capable of associating the target with the hydrocarbon production equipment may be used. In an embodiment, the targets are associated with the hydrocarbon production equipment such that a one-to-one relationship exists between the deformation of the equipment and the deformation of the target. It is believed that a potential advantage of the one-to-one relationship is that this relationship simplifies the calculations necessary to determine the health state parameters, such as stress, strain, and fatigue.

The plurality of targets may be associated with the hydrocarbon production equipment either directly or indirectly and may be associated with the surface or subsurface of the equipment. Examples of means used to associate the target with the hydrocarbon production equipment include indirect application by applying the target in the form of a sticker using an adhesive or direct application with etching, painting, printing, stamping, or laser-marking of a surface. The targets may be associated below the surface of the hydrocarbon production equipment through embedding the target within the equipment when the equipment is formed or associating a target with the equipment and covering the target with an overlying material. Alternatively, the targets may be electromagnetically imprinted within the hydrocarbon production equipment. A magnetizable coating may be used with the hydrocarbon production equipment to improve the ability to create a magnetic imprint on the hydrocarbon production equipment. Alternatively, the magnetizable coating may be embedded within the hydrocarbon production equipment to improve the ability to create a magnetic imprint useful as a target.

Alternatively, the targets may be associated with the surface through the identification of surface or subsurface markings containing identifiable nodes. The existing features may be surface features that define a target on a macroscopic or microscopic scale, or they may be subsurface features that define a target on a macroscopic or microscopic scale.

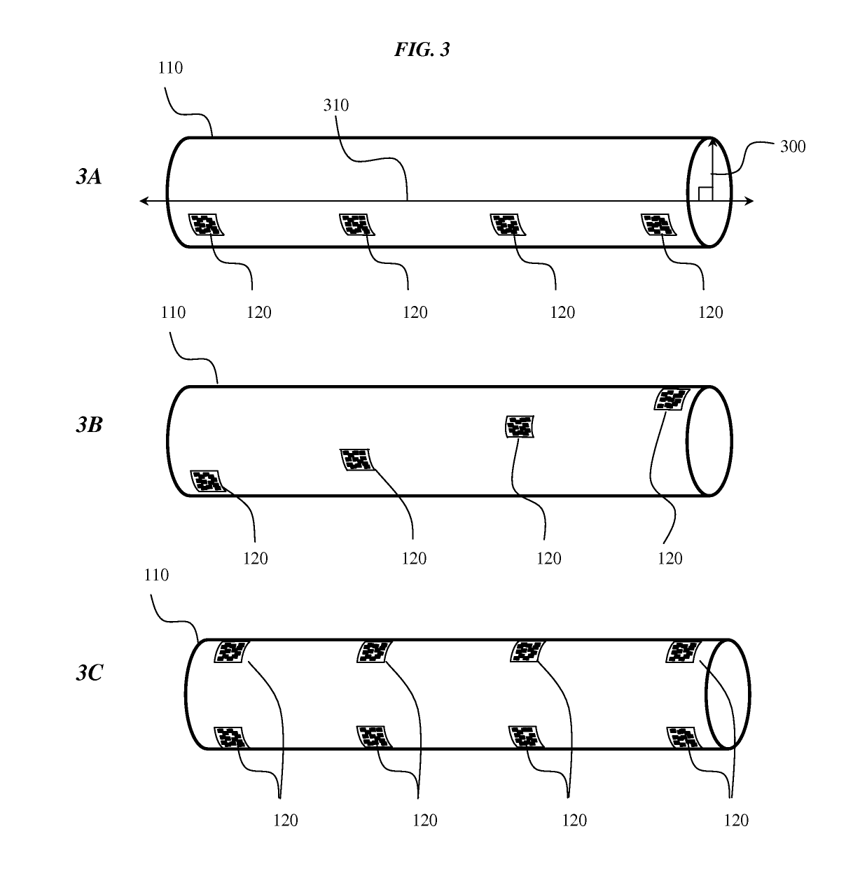

The plurality of targets may be associated with the hydrocarbon production equipment in a variety of patterns. In an embodiment shown in FIG. 3A, the targets 120 may be associated with the equipment 110 in a regular pattern such that the targets are approximately evenly spaced in the longitudinal direction 310, which may also be referred to as the axial direction, of the equipment 110. In this embodiment, the targets may be located several inches to several hundred yards apart. Considerations such as length of the hydrocarbon production equipment, production conditions, target size, and cost may allow one skilled in the arts to determine the frequency with which the plurality of targets 120 are associated with the hydrocarbon production equipment 110. Alternatively, the targets 120 may be associated with the hydrocarbon production equipment with a greater density in certain areas than others. For example, the target density may increase near hydrocarbon production equipment 110 connections or potential failure points. This increase in density may help to increase the accuracy of the health state parameter determinations in the portions of the equipment most likely to fail in addition to the determination of connection integrity. Alternatively, the targets may be randomly associated with the equipment.

In an embodiment shown in FIG. 3A, the plurality of targets 120 may be associated with the hydrocarbon production equipment 110 so that a single target 120 appears at a longitudinal position along the hydrocarbon production equipment. In this embodiment, the plurality of targets 120 may be associated with the equipment 110 in alignment along the longitudinal axis 310 of the equipment. Targets in alignment may be defined as having the same radial offset or displacement along the hydrocarbon production equipment. As used herein, the radial direction 300 is defined as the direction perpendicular to the main longitudinal axis 310 of the hydrocarbon production equipment 110. Without being limited by theory, it is believed that this arrangement would assist in determining if the hydrocarbon production equipment were rotated with respect to a reference position. In another embodiment shown in FIG. 3B, the plurality of targets 120 may be aligned in a spiral along the longitudinal axis 310 of the hydrocarbon production equipment 110. Alternatively, the targets 120 may be aligned at random radial offsets along the longitudinal axis of the hydrocarbon production equipment. In each of these last two embodiments, the initial radial offset or displacement from a reference position may be recorded within the target symbology if a barcode symbol is used to define the target.

In an embodiment shown in FIG. 3C, a plurality of targets 120 may be associated with the hydrocarbon production equipment 110 at a longitudinal position. In an embodiment with two targets located at a longitudinal position, the targets 120 may be arranged so that they are radially offset by 180 degrees from each other. Such an arrangement may allow a sensor to detect at least one target 120 regardless of the orientation of the hydrocarbon production equipment 110. In another embodiment, more than two targets are associated with the equipment at a longitudinal position. In a preferred embodiment, the plurality of targets would be evenly spaced in a radial direction (i.e. 3 targets would be 120 degrees apart, 4 targets would be 90 degrees apart, etc.). In this embodiment, the targets may contain a record of their radial displacement relative to a reference point if the targets are capable of containing information, for example, using a 2D barcode symbol. In an alternative embodiment, the target may comprise a symbol that encircles the hydrocarbon production equipment. Such an embodiment would allow the sensor to observe the target regardless of the orientation between the sensor and the hydrocarbon production equipment. In this embodiment, the target may contain one or more radial direction identifiers for different portions of the target so that the orientation of the hydrocarbon production equipment could be determined from the portion of the target observed by the sensor.

Returning to FIG. 1, the plurality of targets may be observed using one or more sensors 140, as discussed in more detail hereinafter. In order for the targets 120 to be sensed by the sensor 140, the targets may emit a detectable physical quantity. The physical quantity may be emitted by reflection, natural emission, or upon external stimulation. An example of reflection includes the physical quantity produced when a symbol such as a bar code is subjected to an interrogation signal (e.g., a light source) such as produced by a bar code reader. An example of a natural emission of a physical quantity may include a magnetized material that emits a magnetic field. Examples of external stimulation include, without limitation, a material that creates a magnetic field or emits a light when subjected to a current or electrical field. The physical quantity can be a signal in any portion of the electromagnetic or acoustic spectrum. Alternatively, the physical quantity may be a magnetic field.

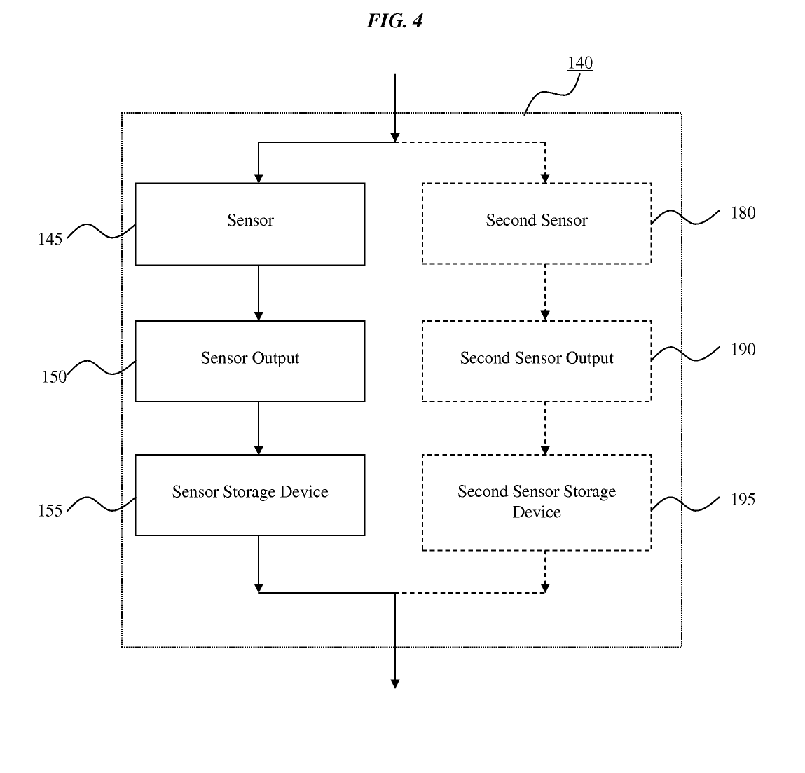

As shown in more detail in FIG. 4, the sensor 145 observes the plurality of targets and returns a sensor output 150. The sensor may be an optical, magnetic, electromagnetic, acoustic, or other sensor, as appropriate and compatible with the plurality of targets and the physical quantities emitted. Sensors capable of detecting these various physical quantities are commercially available and would be apparent to one skilled in the arts in view of the disclosure herein. An example of a suitable sensor for use with the device disclosed herein may be a CCD camera capable of detecting a target that reflects electromagnetic radiation in the visible, ultraviolet, or infrared spectrum. The frequency of such radiation (e.g., a light source) may be selected such that the emitted and reflected light minimizes noise produced by non-target objects such as dirt, equipment shapes/contours/edges, etc. The sensor output comprises data (also referred to as sensed data) associated with the dimensions, positions, locations, orientations, characteristics, and/or spatial relationship of a current or instant state of the targets.

The sensor 145 may be located in any position such that it can observe the targets. The distance between the sensor and target is dependent on the choice of symbols or nodes defining the target. When a 2D barcode is chosen for use as a target, the scaling of the 2D barcode may allow for a sensor to be placed several yards away. Alternatively, if a small scale is chosen for the target, the sensor may need to be placed with several feet or several inches of the hydrocarbon production equipment in order to sense the target. In order to detect the targets on the hydrocarbon production equipment, the sensors may be fixed or have at least one degree of freedom. In a preferred embodiment, the sensor may have two degrees of freedom, including longitudinal and radial, in order to track the targets. This embodiment may allow for the sensor to move relative to the hydrocarbon production equipment in order to observe a target at any location on the hydrocarbon production equipment.

As shown in FIG. 4, the sensor 145 produces a sensor output 150 in response to an observation of the targets 120. The sensor output 150 may be any type of signal compatible with the analysis device receiving the signal. For example, the signal may be an analog or digital signal in a format capable of being utilized by the analysis device, which may be a computer.

The sensor may produce an output on a continuous basis, at random times triggered by an external event, or at pre-determined intervals. In an embodiment, the sensor may produce an output upon detection and recognition of a target. This could occur as the target on the hydrocarbon production equipment passes within an observable distance of a sensor, which may be moving relative to the hydrocarbon production equipment. In an alternative embodiment, the sensor may produce an output at a predetermined time calculated to correspond with the passing of a target within an observable distance of the sensor. In another embodiment, the sensor may attempt to detect a target at approximately regular time intervals and produce an output upon detection of a target within an observable distance and/or upon the non-detection of one or more expected detections (e.g., an alarm signal). As used herein, an observable distance is a distance between the sensor and target at which the sensor may detect the target with sufficient accuracy to determine the spatial relationship between the nodes. This distance may vary based on the target size and type, and the sensor type and sensitivity.

As depicted in FIG. 4, optional one or more additional sensors (e.g., second sensor 180) may be used to detect additional properties of the hydrocarbon production equipment and generate a second sensor output 190 for subsequent use with the analysis device 160. Additional properties of the hydrocarbon production equipment that may be useful in the determination of one or more health state parameters include, but are not limited to, a distance measurement along the hydrocarbon production equipment, the load carried by the equipment, the temperature of the equipment, the pressure inside the equipment, the relative position of the sensor with respect to the hydrocarbon production equipment (both radial and longitudinal), the rate of movement of the sensor, the hydrocarbon production equipment, or combinations thereof. For example, the second sensor may be a mechanical device like a counter (e.g., a roller in contact with production tubing) that increments according to the length of the hydrocarbon production equipment placed in or out of the wellbore. Sensors suitable for the determination of the additional properties of the hydrocarbon production equipment are commercially available and would be apparent to one skilled in the arts with the aid of the present disclosure. The second sensor output generated by the second sensor may be any type of output compatible with the analysis device. For example, the signal may be an analog or digital signal in a format capable of being utilized by the analysis device, which may be a computer.

Referring again to FIG. 4, the sensor 145 may contain a storage device 155 for retaining the sensor output 150 for subsequent use with the analysis device. In an embodiment that includes a second sensor 180, the second sensor 180 may also include a second sensor storage device 195. In an embodiment containing a sensor storage device for the sensor 145, the second sensor 180, or both, the storage device may store the sensor output 150, the second sensor output 190, or both. The sensor storage device 155, the second sensor storage device 195, or both may store the output in tangible media including memory chips, hard drives, a compact disk read-only memory (CD-ROM), a digital video disk (DVD), flash memory, video cassette, a video storage device, or any other type of memory storage drive suitable for storing the sensor output. The storage device could be used to subsequently reproduce the sensor output 150, the second sensor output 190, or both for use with the analysis device. Such delay in the production of the output signal may allow the sensor 145, the second sensor 180, or both to be used with the plurality of targets at a location separate and unconnected from the analysis device, for example in a remote oilfield. Subsequent processing of the sensor output 150, the second sensor output 190, or both by the analysis device may be conducted proximate and/or remote from the sensor and/or the hydrocarbon production equipment and could indicate the health state parameters of the hydrocarbon production equipment prior to a subsequent use of the equipment.

Referring to FIGS. 1 and 4, the analysis device 160 may be used to analyze a change in the relation of the targets and/or nodes. The analysis device is capable of accessing the recorded and sensed data, and for example is coupled to one or more storage devices such as a computer or database containing the recorded and/or sensed data. Alternatively, the analysis device may be coupled to the sensor and receive the sensed data in real time, wherein the sensed data may further comprise recorded data regarding a reference state of the target, sensed data regarding the current state of the target, or both. The analysis device 160 utilizes the recorded data and the sensed data (e.g., the sensor output 150 and optionally a second sensor output 190, if available) to generate one or more health state parameters 170. The analysis device 160 identifies changes in a measured parameter (e.g., dimension and/or position of target) by comparing sensed data for an instant/current state of the parameter to record data for a reference/baseline state of the parameter. For example, the health state parameters may be determined by analyzing a change in the dimensions, positions, locations, orientations, characteristics, and/or spatial relationship of the targets and/or nodes when comparing sensed data associated with a current or instant state to recorded data for a reference or baseline state. In an embodiment, the analysis device 160 determines the overall and local health state parameters 170 of the hydrocarbon production equipment based on changes in the positions and/or dimensions of the target, the spatial changes between the nodes of individual targets, the spatial changes between the plurality of targets, and any optional second sensor output. The analysis device 160 may utilize the principles of Finite Element Analysis to determine the health state parameters, including the local and global stress, strain, and fatigue of the hydrocarbon production equipment.

The analysis device 160 may be any device capable of determining any change in a measured parameter (e.g., dimension and/or position of target) by comprising sensed data for the parameter to record data for the parameter. For example, a machine vision system may be used to identify and track the nodes in the individual targets, and the analysis device may detect a change in the dimensions, positions, locations, characteristics, orientations, and/or spatial relationships of the nodes present within the plurality of targets. A machine vision system may comprise both a sensor producing an output and an analysis device for utilizing the sensor output. The choice of a machine vision system capable of detecting the targets and the physical quantity each target emits or reflects is within the ability of one skilled in the arts with the aid of the present disclosure. In an embodiment, the machine vision system may use algorithms to recognize a target and the nodes within the target. The choice of appropriate algorithms for detecting the targets and nodes is within the ability of one skilled in the arts with the aid of the present disclosure.

A machine vision system may be capable of detecting the nodes within the targets in a variety of ways. One example would be the situation in which the machine vision system utilizes outputs from a sensor that is stationary and observes the hydrocarbon production equipment as it moves past the sensor. For example, the machine vision system could identify nodes in the targets using sensor data obtained from a sensor mounted to a portion of the wellhead equipment observing targets associated with a coiled tubing system being placed into or drawn out of the wellbore. Alternatively, the machine vision system may utilize an input from the sensor as the sensor moves relative to the hydrocarbon production equipment. For example, if the sensor was lowered into a wellbore in which the targets were placed in an observable position on the casing.

As shown in FIG. 1, the analysis device 160 may be capable of identifying the current or instant state of targets and/or nodes or points contained in the targets and identifying the spatial relationship of the targets/nodes relative to one another. The current/instant spatial relationship of the targets/nodes may then be compared to a recorded reference/baseline state of the target/nodes to determine the health state parameters 120 of the hydrocarbon production equipment. For example, the difference in the spatial relationship of the targets/nodes relative to the reference/baseline positions and/or dimensions could be measured and compared over a plurality of services performed using the hydrocarbon production equipment to determine the localized stress or strain under which the material is subjected or has been subjected. A variety of equations may be used to determine the health state parameters from the spatial changes in the points or nodes. For example, the principles of Finite Element Analysis may be used to convert the spatial changes into health state parameters including stress, strain, and fatigue. Other health state parameters may then be determined based on these values. Any suitable method of performing finite element analysis may be employed as would be apparent to one skilled in the arts with the aid of the present disclosure. An example of suitable finite element analysis is provided in Stephens, Ralph I., Fatemi Ali, Stephens, Robert R., and Fuchs, Henry O., Metal Fatigue in Engineering, Second Edition, John Wiley & Sons, Inc. New York 2001, which is incorporated herein in its entirety. Approximation techniques useful with individual targets are further described in U.S. Pat. No. 6,874,370 B1 to Vachon and U.S. Pat. No. 6,934,013 B2 to Vachon and Ranson, both of which are incorporated herein in their entirety.

The analysis process described in FIG. 1 looks to explain the fatigue derived of continuous stress applied on hydrocarbon production equipment. Stress σ is defined as the ratio of the perpendicular force F applied to a specimen divided by its original cross sectional area A or algebraically σ=F/A. The stress could be classified into tensile stress where purely sheer force is applied and shear stress where force is applied parallel to the surface. The stress will generate variations in the positions and/or dimensions of the targets associated with the hydrocarbon production equipment. This change in positions and/or dimensions is represented by a strain measurement or the ratio of change in length due to the deformation (ε=(Lᵢ−Lₒ)/Lₒ=ΔL/lLₒ). Stress and strain are through different constants, like the Hooke's Law for relatively low levels of tensile stress. Generally, metallic materials like the ones used in hydrocarbon production equipment will have elastic deformation to strains of about 0.005. After this point a plastic or non-recoverable deformation will occur and relations like Hooke's law are no longer valid. On an atomic level atomic bonds that are broken and create new bonds cause this deformation. After a hydrocarbon production equipment is subject to stress some of the total deformation is recovered as elastic deformation. Approximation techniques described in U.S. Pat. No. 6,874,370 B1 to Vachon and U.S. Pat. No. 6,934,013 B2 to Vachon and Ranson, explain different techniques to recover total strain fatigue from the targets.

Returning to FIG. 1 and FIG. 4, the analysis device 160 may be any system or device capable of determining one or more health state parameters 120 from the sensor output 150, the second sensor output 190, or both. In an embodiment, the analysis device may be a computer capable of determining the health state parameters 120, wherein the computer may have a processor, a user interface, a microprocessor, memory, and other associated hardware and operating software. The analysis device 160 may be, for example, one of the models of personal computers available from International Business Machines Corporation of Armonk, N.Y. The analysis device 160 may be a component of the same device containing the sensor 140, for example when a machine vision system is used. In an alternative embodiment, the analysis device 160 of the present disclosure may be operated using a computer separate from the sensor. This embodiment could allow for post processing of the sensor output at a location separate from the sensor and hydrocarbon production equipment location. While specific examples are listed, a number of system variations exist and are believed to be within the spirit and scope of the present invention. In an embodiment, the analysis device and/or sensor comprises one or more programs or software operating on a general computer system as described herein.

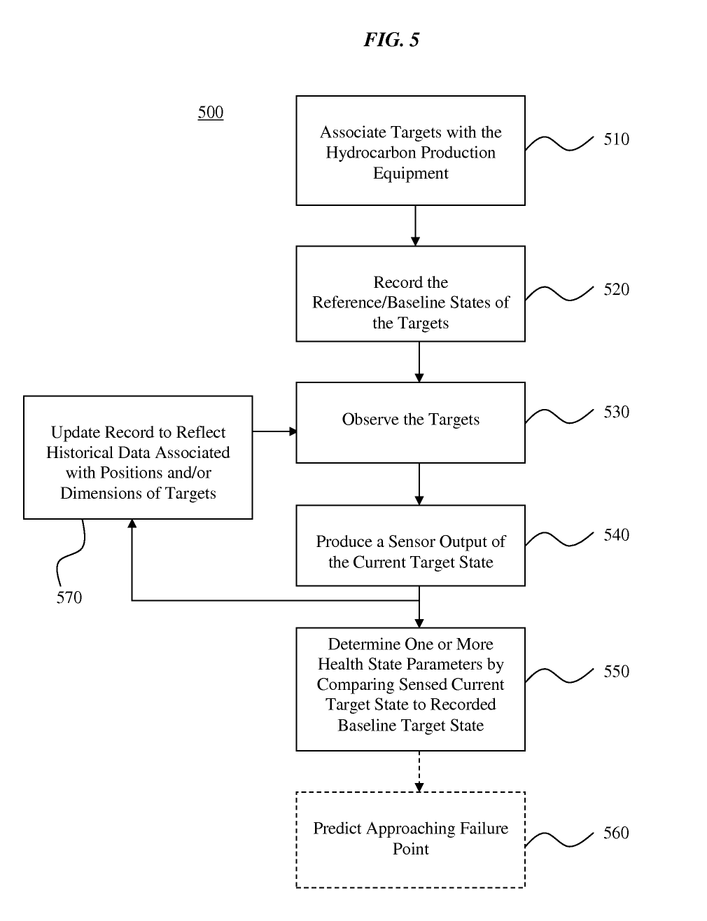

As shown in FIG. 5, the apparatus described in the present disclosure can be used to determine the health state of hydrocarbon production equipment. In an embodiment, the method 500 initially involves the association of targets with the hydrocarbon production equipment at block 510, provided that such association has not already been performed in which case the method may initiate at block 530. The targets may be associated with the hydrocarbon production equipment using any of the methods described above. The reference or baseline state of the targets may be recorded at block 520, for example to create an OEM or retrofit record containing data associated with the original state of the targets upon OEM or retrofit. The record may be created in information contained within the targets themselves or it may be maintained in another source external to the hydrocarbon production equipment. The positional and/or dimensional data/values stored in the record may serve as baseline data which may be compared to sensed data (e.g., observational output) to determine health state parameters. The targets are then observed at block 530 and an observation output is produced at block 540. The output may optionally be used to update the record to provide a historical record of the dimensions and/or positions of the targets as shown at block 570, and thus the record may contain baseline/reference data associated with the state of targets during previous uses of the equipment as well as the state of the targets at the time of original placement on the equipment at OEM or retrofit. Such record may be stored in memory as described previously or may be stored within the targets, provided the targets are capable of being updated or overwritten with such data. The baseline/reference state data (e.g., dimensions, positions, locations, orientations, characteristics, and/or spatial relationships) for the targets and/or the nodes within the plurality of targets is then correlated/compared with the corresponding sensed or observed state data (e.g., dimensions, positions, locations, orientations, characteristics, and/or spatial relationships) for the targets that is contained within the sensor output. The correlation/comparison results in a determination of one or more health state parameters at block 550. The health state parameters may be used to determine the overall health and remaining useful life of the hydrocarbon production system. As a part of this overall health state determination, the method may optionally be used to predict an approaching failure point for the hydrocarbon production system at block 560. For example, historical data in the record may be trended and compared to known failure patterns to predict the likelihood of same. The prediction of the failure point may allow the system to be repaired in order to extend the useful life of the equipment. In an embodiment, the method shown in FIG. 5, and in particular blocks 530, 540, 550, 560, and 570, may be repeated over time (e.g., iteratively) to provide an equipment health history of the hydrocarbon production equipment which may be used for maintenance scheduling, end of service life determinations, suitability for intended use determinations, etc.

In an embodiment, the apparatus and method disclosed herein may be used to determine the health state parameters for production conduit and transmission equipment. As noted above, production conduit includes equipment such as coiled tubing, wellbore casing, jointed tubing, production tubing, drill pipe, and fracturing tubing. Transmission equipment includes equipment used to transport tools, equipment, or signals within a wellbore. Examples of transmission equipment include, without limitation, slickline, and wireline. Production conduit and transmission equipment generally experience fatigue and stress due to placement into and out of the wellbore. As such, the targets may be associated with the hydrocarbon production equipment in a manner allowing the health state parameters to be determined that would assist in monitoring the equipment for this type of wear.

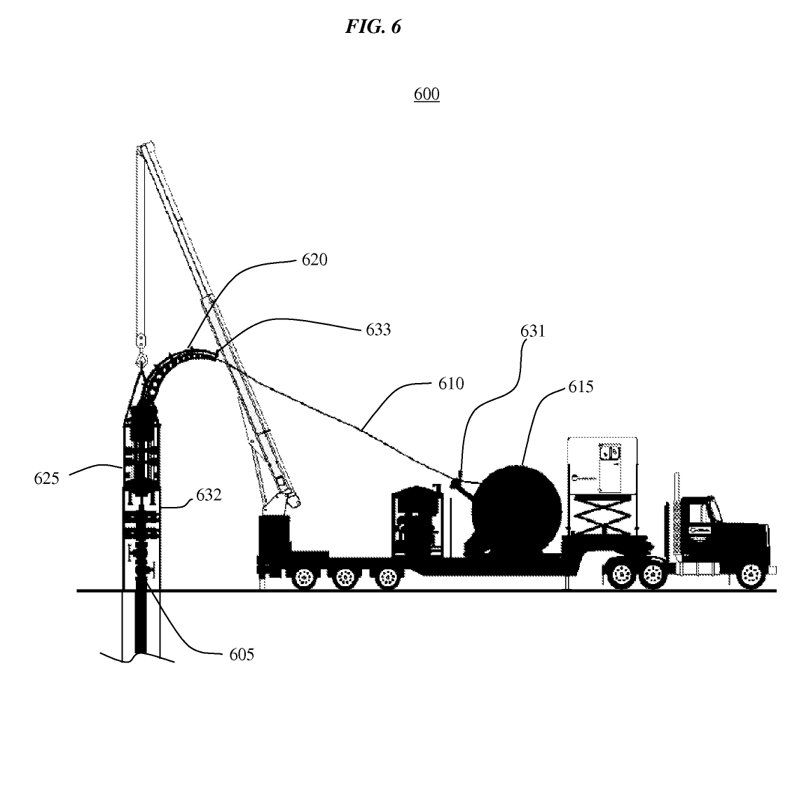

FIG. 6 illustrates an embodiment utilizing the disclosed apparatus and method. While the system may be used with any production conduit or transmission equipment, for the purposes of illustration, a coiled tubing unit will be further described. In this embodiment, the hydrocarbon production equipment is a coiled tubing unit 600. The coiled tubing unit 600 consists of coiled tubing 610 that is initially contained on a spool 615 and is fed into a wellbore 605 through the wellhead equipment. A wheel or arc support, which may be referred to as a gooseneck, 620 receives the coiled tubing from the spool 615, reshapes it, and directs it into the injector 625. The injector assists in introducing the coiled tubing into the wellbore while maintaining a seal between the wellbore and the atmosphere. The coiled tubing 610 may also be run out of the wellbore using the same equipment used to feed the coiled tubing into the well. When the coiled tubing is being run out of the hole, the injector 625 and gooseneck 620 operate to remove any wellbore fluids on the coiled tubing 610 and assist in placement of the coiled tubing back onto the spool 615. The coiled tubing 610 may experience fatigue as it is cycled over the gooseneck 620 and onto the spool 615. The number of cycles before failure is largely a function of the pressure inside the coiled tubing 610. The use of the disclosed apparatus and method may allow an accurate measure of the fatigue in the coiled tubing so that the useful life can be extended as long as possible.

In accordance with the present disclosure, the health state parameters of the coiled tubing 610 may be determined using the methods disclosed herein. In the embodiment show in FIG. 6, the targets are initially associated with the coiled tubing 610. The targets may be DMS markings and may be placed at approximately regular intervals along the coiled tubing 610 or more closely at specific locations of the coiled tubing 610, like connectors or in areas where possible problems may arise. The DMS markings may also be placed in an approximately linear fashion along the longitudinal direction of the coiled tubing with approximately the same radial offset. Alternatively, the DMS markings may be placed in a spiral pattern around the coiled tubing or multiple targets may be placed at a given location on the coiled tubing offset in the radial direction. For example, two DMS markings may be placed at a location on the coiled tubing where each target is offset by one hundred eighty degrees in the radial direction from the other target.

The baseline positions and/or dimensions (e.g., the initial and/or historical data) of the targets may be recorded. In the embodiment depicted in FIG. 6, the record of the target positions and/or dimensions may be contained in the DMS markings themselves. For example, the distance of each target from reference point may be encoded within the DMS markings themselves, which may be read by the sensor. In an embodiment in which multiple targets are present at a given length along the coiled tubing, the DMS markings may also contain radial offset information capable of being read by the sensor. Such rotational data might be useful in determining the rotational position of the coiled tubing at the sensor. Alternatively, a record may be created of the positions and/or dimensions of each target on the coiled tubing spool, and the record may then be updated and maintained with the coiled tubing spool during its useful life. The record may then be used along with the sensor output to generate the health state parameters for the coiled tubing unit for example by comparing sensed data to initial and/or historical baseline data for dimensions and/or positions of the targets.

In an embodiment shown in FIG. 6, one or more sensors may be used to observe the targets on the coiled tubing 610. In this embodiment, the sensor may be a camera placed at one of locations 631, 632, or 633. While only one sensor may be required for a determination of the health state parameters, more than one sensor may be used to observe the targets on the coiled tubing. Multiple sensors may allow for an increased accuracy in reading the targets and may allow for rotational measurements by observing the coiled tubing at two locations. The use of multiple sensors may allow the detection of targets on either side of the coiled tubing if only one target is used per radial location. Alternatively, each camera may rotate around the coiled tubing at its location in order to sense the target on the coiled tubing. The use of multiple sensors in this embodiment may allow the rotational state of the coiled tubing to be measured at each observation point, indicating the torque on the coiled tubing as is moves between the wellhead 605 and the spool 615.

A second sensor for measuring additional coiled tubing properties may be present at one of locations 631, 632, or 633. For example, the second sensor may be a mechanical device like a counter that increments according to the length of the coiled tubing placed in or out of the wellbore. Most coiled tubing units have measurement devices suitable as second sensors including load monitors and rollers for measuring the length of coiled tubing placed in or out of the wellbore. These sensor outputs could be useful for determining one or more health state parameters of the coiled tubing unit.

The one or more sensors shown in FIG. 6 may produce sensor outputs for use with an analysis device. The analysis device may then be used to determine one or more health state parameters for the coiled tubing system. In determining the health state parameters, the analysis device compares the recorded baseline (e.g., initial and/or historical), and sensed actual positions and/or dimensions of the targets. In this embodiment, the health state parameters derived from such comparison include a measurement of the rotation and torque, pressure inside the coiled tubing, temperature of the coiled tubing, a depth correction measurement, and a fatigue measurement for the coiled tubing. The use of 2D barcodes or symbols on the coiled tubing would also allow a measurement of the ovality of the coiled tubing and a change in the curvature of the surface throughout its useful life. The health state parameters are determined both on a localized basis around each target and on a general coiled tubing basis. The health state parameters may be compared to equipment specifications to determine whether the hydrocarbon production equipment is suitable for a given service, needs maintenance or service, etc. For example, the localized measurements may optionally allow a determination of whether a particular segment is outside of the specifications for the tubing for a particular use and may be used to predict an approaching failure point within the localized area. Such a determination may allow the coiled tubing or a section of coiled tubing to be repaired prior to failure of the tubing during use. The general health parameters may include, among other parameters, an overall elongation measurement and an average fatigue measurement. These would indicate if the coiled tubing as a whole would be suitable for a designated workover procedure. Considerations such as anticipated pressure and fluid type may be used to determine if the coiled tubing is suitable for use on a designated workover procedure.

As discussed above, production conduit includes equipment such as coiled tubing, wellbore casing, jointed tubing, production tubing, drill pipe, and fracturing tubing. The production conduit may be used to transport tools into and out of the wellbore. In order to transport tools and tubing into a wellbore, one or more connections are usually made and may comprise threaded connections, such as box threads or threaded collar connections. An important aspect of the connection that may be monitored using the disclosed apparatus and method includes the integrity of the connection once made.

In an embodiment, the apparatus and method disclosed herein may be used to determine the integrity of a connection in conduit or hydrocarbon tools. In general, the integrity of a connection can only be determined once the connection has been created, which may be referred to as “making up” the connection. Upon pressurization of the connection, a leak may occur at any one of several seals usually present in a hydrocarbon production equipment connection. Typical testing equipment may observe the connection for a time period to determine if any hydrocarbons can be detected on the exterior of the connection. This method is not always reliable, as a leak may not be detected if any one of the seals is viable, even if all of the other seals have failed. It would therefore be advantageous to have a method of testing a hydrocarbon production equipment connection that could detect if any one of several seals has failed, as evidenced by one or more health state parameters.

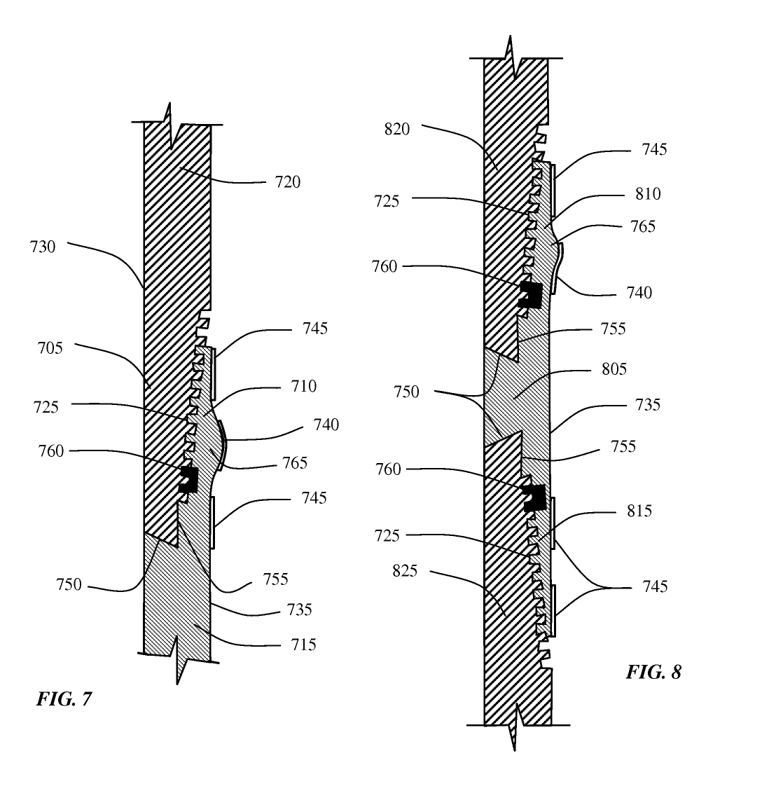

The disclosed apparatus and method may be used to determine if any one of a number of seals have failed in a variety of conduit and tool connections. Examples of common connection types include, without limitation, pin and box threaded connections and coupling type threaded connections. A typical pin and box threaded connection is shown in FIG. 7. This type of connection is characterized by a sleeve-shaped member having an axis coaxial with the axis of the conduits. The connection includes a pin member 705 formed at the end of one conduit 720 with the box member 710 formed at the alternative end of another conduit 715. The pin and box members are mechanically coupled by threads 725. The main flow path through the conduit once connected is through the generally cylindrical interior pathway defined by the interior surface 730 of the conduits, which approximately align upon connection. The connection also has an exterior surface 735 on which targets 740, 745 may be placed.

The pin and box connection includes four common types of seals that may be monitored. The first seal is a metal-to-metal shoulder or end seal 750, which may include a face that is either perpendicular to the axis of the conduits 715, 720 or slightly inclined with respect to a face perpendicular to the axis. The second type of seal includes a metal-to-metal flank seal 755 spaced slightly away from the shoulder seal. The flank seal 755 is typically inclined or tapered with respect to the axis of the conduits 715, 720. The third type of seal depicted is an elastomeric seal 760, which may have either a circular or rectangular cross-sectional configuration and may be formed from any suitable rubber, elastomeric, or metal/rubber/elastomeric material. The fourth type of seal is a mating seal formed by the mating threads 725. The threads generally provide at least a temporary seal against leaks but may not be a reliable seal over time.

FIG. 8 demonstrates another type of connection that may be used to form hydrocarbon conduit and tool connections. Such a connection may be used with wellbore casing or drill collar connections. The connection coupling 805 has two ends 810, 815 that form threaded box connections for coupling to pin connection ends 820, 825 that may be present on a hydrocarbon conduit, a tool, or both. The connection may include one or more of the seals including a shoulder seal 750, flank seal 755, an elastomeric seal 760, and a mating thread seal 725 discussed above for preventing leaks and ensuring the integrity of the connection once made. The connection coupling 805 also has exterior surface 735 on which targets 740, 745 may be placed.

When a connection is formed, one or more seals should substantially prevent fluid from passing from the interior of the conduit to the exterior of the conduit through the connection. In some embodiments, the seals may substantially prevent fluid from passing from the exterior of the conduit to the interior of the conduit. If one or more seals fail, the fluid pressure will cause the space between the failed seal and the held seal to pressurize. This pressurization may cause a deformation 765 of the connection materials at the point of pressurization. The deformation 765 may result in a deformation at the exterior of the surface of the coupling. The deformation 765 illustrated in FIGS. 7 and 8 is exaggerated for purposes of explanation. The deformation shown in FIGS. 7 and 8 demonstrates that the conduit or tool forms an overall reliable connection as the seal formed by the threads 725 has held. However, the shoulder seal 750, the flank seal 755, and the elastomeric seal 760 has failed as evidenced by the deformed exterior surface 765 at a position radially outward of and axially at a position between the connection formed by the threads 725 and the elastomeric seal 760. In an embodiment, the deformation 765 may occur at any point along the one or more seals. The location and size of the deformation 765 may be used to indicate which of the seals, if any, have failed. It may also be expected that as the connection is pressurized, the entire connection area may expand. However, a leak may be detected by observing a deformation 765 in excess of the surrounding connection material.

The apparatus disclosed herein may be used to detect a deformation 765 caused by a failed seal during pressurization of the connection. In an embodiment illustrated in FIGS. 7 and 8, a plurality of targets 740, 745 may be associated with the hydrocarbon conduit and tool connections. The hydrocarbon conduit or tool may have one target per connection point in an embodiment with two connection points per hydrocarbon conduit or tool. In an alternative embodiment illustrated in FIGS. 7 and 8, a plurality of targets 740, 745 may be applied to the portion of the hydrocarbon conduit or tool near the connection point. The choice of the number of targets per connection area may depend on the choice of target nodes and size.

In an embodiment as shown in FIGS. 7 and 8, the targets associated with the hydrocarbon conduit or tool may deform along with the connection material (e.g., deformation 765) during pressurization. In such a case, the targets 745 not located at or near a deformation area may remain relatively unchanged, though a slight deformation is expected due to the pressurization of the connection. A target 740 located at or near a deformation 765 may be expected to deform along with the connection material. The deformation of the target may then be used along with the record of the target position and/or dimension, a sensor, and an analysis device to determine one or more health state parameters. In this embodiment, the stress and strain may be used to indicate a deformation at the connection, a failure of one or more seals, or combinations thereof.

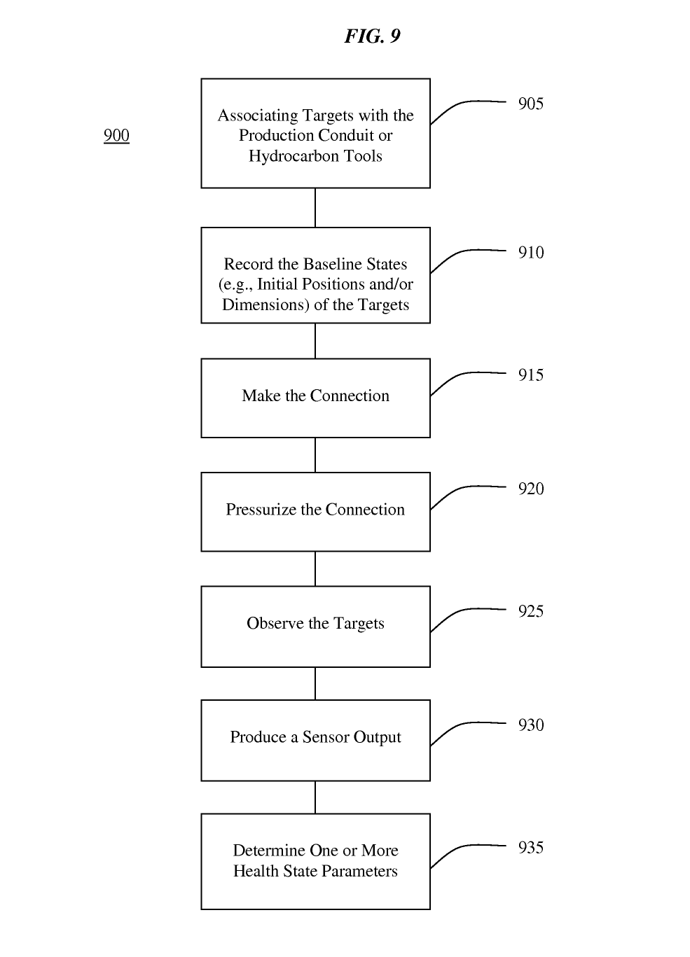

As shown in FIG. 9, the apparatus may be used to perform a method 900 for detecting the connection integrity of hydrocarbon conduit and tool connections. Initially, the targets may be associated with the hydrocarbon production equipment at block 905, which in this embodiment, may be one or more connectors or connector components of hydrocarbon conduit or tools. The baseline/reference states of the targets (e.g., initial positions, orientations and/or dimensions of the targets) may be recorded at block 910. The record may be used to indicate both the location and orientation of the targets on the hydrocarbon conduit or tools. As noted above, the record may be contained within the target if the target is capable of containing information. If targets are already associated with the hydrocarbon production equipment and a record exists, the method may initiate at block 915.

A connection may be made using the hydrocarbon conduit or tool at block 915. The connection may have one or more seals and may be capable of maintaining a pressure differential across the connection. The connection may be pressurized at block 920. The connection may be pressurized using any known techniques as would be apparent to one skilled in the arts. In an embodiment, the connection may be pressurized by using one or more packers to isolate the area of the connection. The packers may also provide the conduit through which pressurized fluid used to pressurize the connection may be introduced into the connection area. In an embodiment, the connection may be pressurized so that a lack of connection integrity may be determined. The pressure utilized to test the connection may be on the order of the pressure experienced by the connection when in use. In an embodiment, the hydrocarbon conduit and tool connections testing using the disclosed method may be pressurize to between 5,000 psi and 20,000 psi. The previous pressure range is an example for an embodiment, other pressure range could be used based on the tool final application.

As shown in FIG. 9, the targets associated with the connection may be observed at block 925. The targets may be observed using a sensor compatible with the plurality of targets. In an embodiment, the sensor may be a camera associated with a machine vision system and the targets may be 2D barcode symbols. The sensor may be capable of detecting a very small change in the targets associated with the connection that may indicate a deformation. In an embodiment, a second sensor may also be utilized. For example, the second sensor may be a pressure monitor capable of determining the pressure within the connection. The second sensor readings may be used along with the observation of the targets to determine the health state parameters, including the stress and strain of the connection. In this embodiment, the localized stress and strain of a target associated with a deformation, if present, are the preferred health state parameters measured. The connection may be observed for a time period sufficient to detect a lack of connection integrity. In an embodiment, the observation time may be from several seconds to several minutes, for example, from 10 seconds to 3 minutes. Due to the need for a fast connection test time, the preferred pressure test observation time would be less than one minute.

The sensor produces an output at block 930 that may be used to determine the one or more health state parameters of the connection. In an embodiment with a second sensor, the second sensor may also produce a second sensor output. For example, the second sensor output may be the pressure reading of the internal pressure of the connection. The sensor output, the optional second sensor output, or both may then be used to produce one or more health state parameters. In an embodiment, an analysis device such as a computer may be used to compare the record to the output received from the sensor, the second sensor, or both to produce the health state parameters at block 935, as described in more detail herein.

As noted above, one or more health state parameters may be used to indicate the presence or absence of a deformation at the connection. In this embodiment, a deformation may indicate a seal failure and a lack of connection integrity. Such a connection may be unconnected and remade, or replaced prior to being placed in service. Alternatively, a lack of a deformation at the connection may indicate that the seals have held and that the connection is acceptable for its intended use.

A determination of whether a deformation of the connection material exists may take all of the target readings into account. As the entire connection is expected to slightly deform outward in response to an increase internal pressure, a deformation must be determined relative to the overall slight expansion. The location of a deformation may be determined by observing one of the plurality of targets relative to the others to determine if a differential expansion has occurred. Alternatively, if only one target is associated with the end of the hydrocarbon conduit or tool, then portions of the target may be observed to determine if a differential expansion of a portion of the target has occurred relative to other areas or the overall target. Such a differential expansion would indicate the presence of a deformation indicative of a seal failure. If a plurality of targets are located on or near a connection point of a conduit or tool, the relative positions and/or dimensions of the targets may also be used to indicate a deformation. For example, the radial distance, axial distance, or both may be used to determine if a deformation has occurred between two targets.

The location of the deformation relative to the overall connection may be used to determine which seal has failed. For example, a deformation occurring in an axial direction that corresponds to a position along the seal formed by the connection threads after the elastomeric seal would most likely indicate that the seal formed by the threads has held while the elastomeric seal and any other seals between the interior of the conduits and the elastomeric seal have failed. Indication of which seals have failed may allow one or more seals to be repaired or replaced.

In an embodiment, the apparatus disclosed herein may be used to determine the torque between segments of hydrocarbon production equipment. Some types of hydrocarbon production equipment form connections through threaded connections (for example, connectors such as shown in FIGS. 7 and 8), which may include the use of additional threaded couplings such as drill collars in between individual hydrocarbon production equipment segments. An important aspect of forming these connections is the ability to obtain an accurate measurement of the torque applied when forming the connection between each segment. An aspect of the disclosed apparatus and method may be the ability to measure the torque between segments of hydrocarbon production equipment without the need for a torque gauge being in contact with the segments being connected. As used herein, a segment refers to a section of hydrocarbon conduit, an individual hydrocarbon tool, a connector component (e.g., collar), or an otherwise identifiable component of the hydrocarbon production equipment.

The torque between segments of hydrocarbon production equipment may be determined using the apparatus disclosed herein. In this embodiment, the hydrocarbon production equipment may be any equipment that requires torque in order to form a connection. For example, the hydrocarbon production equipment may be hydrocarbon conduit or a hydrocarbon tool, both of which may form threaded connections for example, via pin and box connections such as shown in FIGS. 7 and 8.

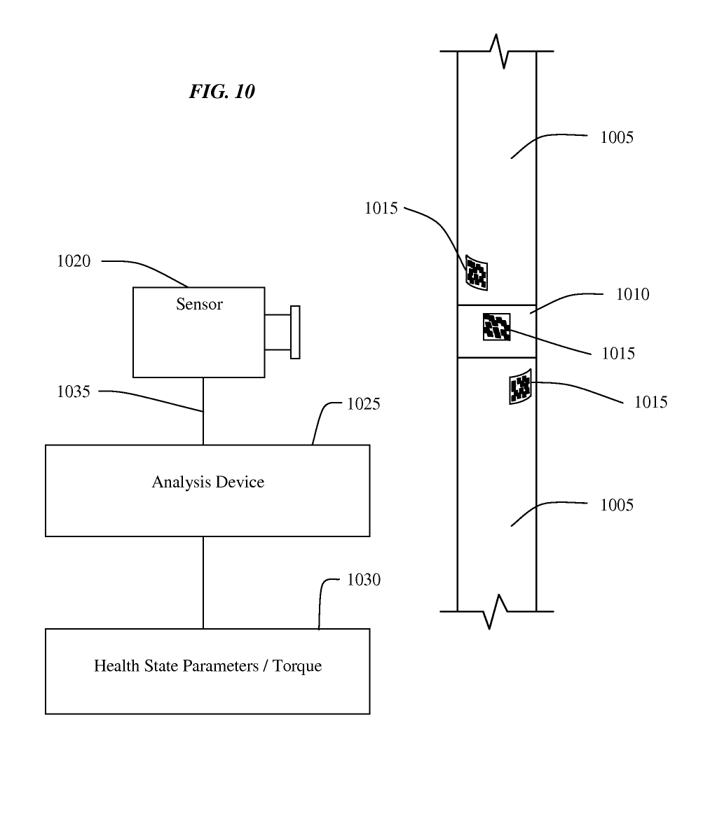

As shown in FIG. 10, the hydrocarbon production equipment 1005 has a plurality of targets 1015 associated with it. The targets 1015 may be of any of the types discussed herein. The targets may be associated with the hydrocarbon production equipment such that a single target or multiple targets may appear on each end of a segment of equipment. Multiple targets may be associated with each end of the equipment in order to ensure that a sensor can observe at least one target regardless of the orientation of the equipment upon forming the connection. If a connection collar 1010 is used to connect individual segments of hydrocarbon production equipment 1005, a target 1015 may be associated with the connection collar 1010.

Upon making up a connection, a record of the positions, dimensions, orientations and/or configuration of the targets may be created. The record may be contained in an external source or it may be contained in the targets themselves, for example, when the targets are capable of communicating information.

As shown in FIG. 10, a sensor 1020 may then be used to observe the targets 1015. The sensor is compatible with the physical quantity emitted by the targets. In an embodiment, the sensor may be a camera or a component of a machine vision system. The sensor may be located at or near the location at which connections are made between segments of hydrocarbon production equipment. For example, the sensor may be located on the drill rig floor where connections are made prior to placing the equipment down hole. A second sensor may also be used to detect additional properties of the hydrocarbon production equipment. For example, a second sensor may be present to indicate the orientation of the equipment and targets in order to allow the sensors to observe the targets. The sensor 1020, the second sensor, or both may produce a sensor output 1035 that may be used by an analysis device 1025 to determine the torque between the individual segments of hydrocarbon production equipment 1005.

An analysis device 1025 may be used to determine one or more health state parameters 1030 using the record of the target positions and/or dimensions and the sensor output 1035, the second sensor output, or both. The health state parameters produced may be any of the parameters discussed herein. For example, the health state parameters may be the stress or strain at or near one of the targets. The stress or strain reading at a target may indicate the force tangential to a surface in the radial direction at one or more targets. The torque at the connection may be determined by multiplying the distance from the center of the hydrocarbon production equipment to the target, which may be supplied by a user or a second sensor, by the force tangential to the equipment at the target. Alternatively, the average of the stress determined at one or more targets on each segment of hydrocarbon production equipment may be utilized. In yet another embodiment, a tangential stress or strain may be determined by considering measurements from a plurality of targets in addition to measurements such as a change in the relative positions and/or dimensions of the targets.

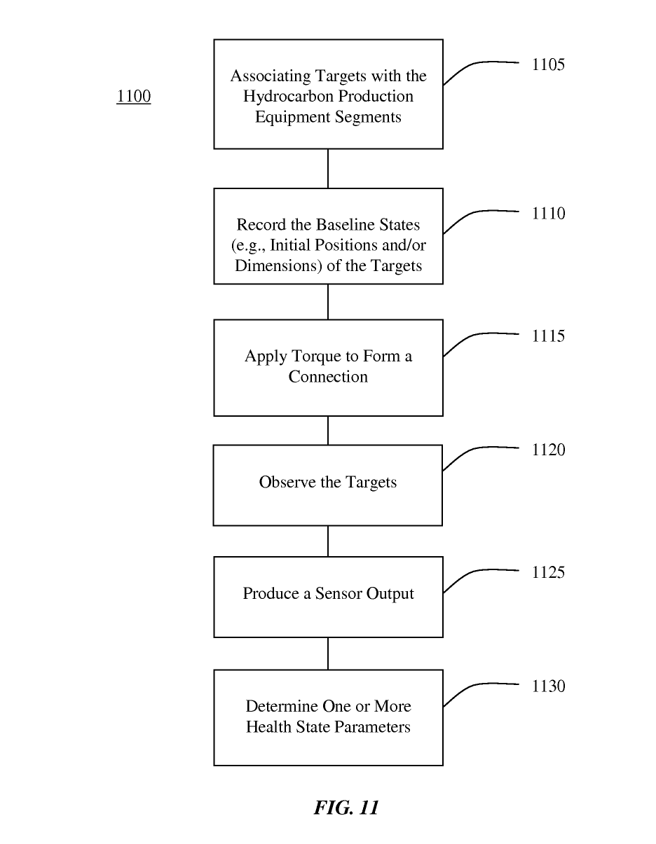

As illustrated in FIG. 11, the apparatus disclosed herein may be used to perform a method 1100 of determining the torque between segments of hydrocarbon production equipment. The method may begin by associating targets with the hydrocarbon production equipment at block 1105. The targets may be associated with the hydrocarbon production equipment such that a single target appears at or near the end of a segment of hydrocarbon production equipment. Alternatively, a plurality of targets may be associated at or near the connection point of a segment of hydrocarbon production equipment.

The baseline/reference states of the targets (e.g., initial positions, orientations and/or dimensions of the targets) may be recorded at block 1110. The baseline data may be recorded in an external or independent log. Alternatively, the record of the baseline data may be contained in the targets if the targets are capable of containing information. If targets are already associated with the hydrocarbon production equipment and a record exists, the method may initiate at block 1115.

A connection is made and torque may then be applied to the hydrocarbon production equipment segments to form a connection at block 1115. The torque may be applied using any means capable of applying a force to the segments. Such means are apparent to one skilled in the arts and may include the use of power tongs.

The targets may be observed at block 1120 before, during, or after the torque is applied to the segments. In this embodiment, the targets may generally be observed during the application of torque to the hydrocarbon production equipment segments. The sensor may produce a sensor output in response to observing the targets at block 1125.

One or more health state parameters may then be produced at block 1130 by comparing sensed state data with baseline state data as described in more detail herein. For example, a stress reading, a strain reading, or both may be produced for further use in determining the torque between the segments of hydrocarbon production equipment. The methods discussed previously may be used to determine the stress and strain as indicated by the change in the spatial relationship of one or more nodes in the targets. In this embodiment, the targets will generally be observed during the application of torque to the segments. Such an observation allows for the torque to be determined and a reading produced during the connection of the segments. Preferably, the production of the torque measurement will occur at approximately the same time as the observation. Such a system allows the operator of the connection equipment to determine if a greater amount of torque should be applied to the segments or if the connection satisfies the torque specifications. Alternatively, the determination of the torque could be utilized as an input to the connection equipment. Upon reaching the desired torque for a given connection, the connection equipment may automatically cease applying a force to the segments.

An additional embodiment of the disclosed apparatus and method may allow for the monitoring of hydrocarbon production equipment tools. As noted above, hydrocarbon tools refer to both down hole tools in addition to equipment and tools used on the surface to support hydrocarbon activities. In addition to the specific examples listed above, equipment used to support and redress tools may also be considered hydrocarbon production equipment tools.

The apparatus disclosed herein may be used to monitor the health state parameters of hydrocarbon tools over their useful lives in order to determine when repair or replacement of parts or the entire tool is necessary. In general, hydrocarbon tools may experience stress, strain, and fatigue due to a variety of causes. Common causes include expansion due to internal pressure differentials and deformation of the parts due to internally applied forces used to operate the tools. For example, many tools are hydraulically operated. Such operations may cause fatigue due to increased internal pressures. Alternatively, the fluids used to hydraulically operate the tool may become trapped in portions of the tool. Upon removing the tool from the wellbore, the trapped fluids may exert a pressure on the tool or components of the tool causing it to deform. Alternatively, mechanical forces may be used to operate some tools. Such forces may cause material deformations that may make the tool unsuitable for its intended purpose. For example, internal slips used in some packers may cause the inner mandrel to deform. As another example, the external slips on some packers may cause the casing to deform upon setting. This wear may eventually make a hydrocarbon production tool unsuitable for its intended use. While an embodiment of a packer is used to demonstrate the apparatus in determining hydrocarbon tool properties, the apparatus may be used with any hydrocarbon tools.

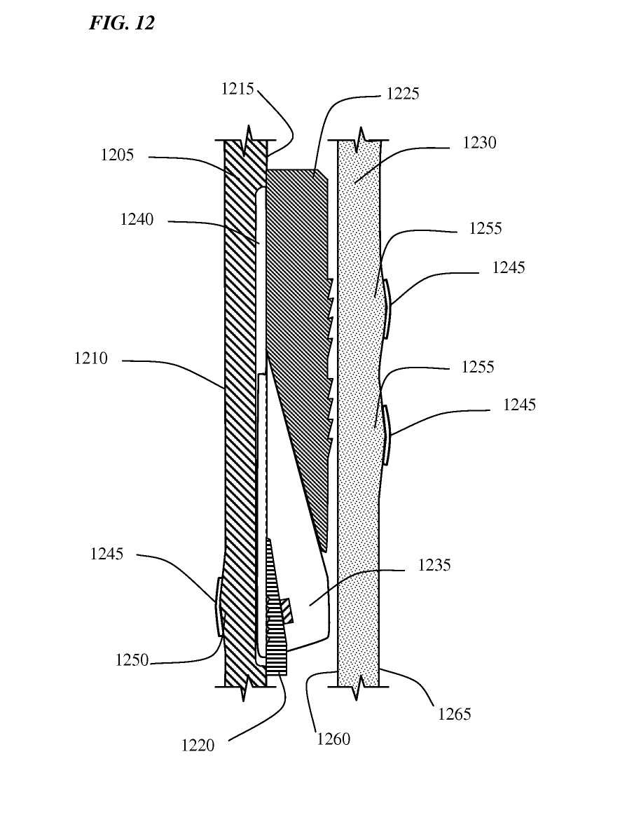

FIG. 12 illustrates an example section of a packer that may be monitored using the disclosed apparatus. The section includes an inner mandrel 1205 with an inner surface 1210 and an outer surface 1215, where the term “inner surface” refers to a surface closer to the center of a wellbore and the term “outer surface” refers to a surface closer to the wellbore wall or casing. The inner mandrel 1205 may be contacted by an internal slip 1220. The internal slip 1220 may prevent the movement between the internal slip 1220 and the inner mandrel 1205. An internal setting slip 1225 may engage an outer mandrel 1230 if engaged by a wedge 1235 that may slide in slot 1240 in the inner mandrel 1205. The outer mandrel 1230 may have additional setting slips to engage wellbore casing upon being set. Other packer configurations may be employed as would be apparent to one skilled in the art with the aid of the present disclosure.

As shown in FIG. 12, the apparatus of the present disclosure may include the use of a plurality of targets 1245 associated with the hydrocarbon production tool. The targets may be associated with the hydrocarbon tool at or near a location in which a mechanical or hydraulic force may be expected to exert a force on the tool. As show in FIG. 12, the targets 1245 may be associated with the inner 1205 and outer mandrels 1230 at a location opposite the contact points of the internal slip 1220 and the internal setting slip 1225. It may be expected that these locations would experience wear or fatigue as the slips are repeatedly set and released during use. A deformation 1250 may occur on the inner surface 1210 of the inner mandrel 1205 at a location corresponding to the location on the outer surface 1215 of the inner mandrel 1205 at which the inner slip 1220 contacts the inner mandrel 1205. A target 1245 may be associated with the inner mandrel 1205 at or near this location. Deformations 1255 may also occur on the outer surface 1265 of the outer mandrel 1230 at a location corresponding to a location at which the inner setting slip 1225 contacts the inner surface 1260 of the outer mandrel 1230. Targets 1245 may also be associated with the outer mandrel 1230 at this location. In an alternative embodiment in which a uniform force is exerted on a hydrocarbon tool component or it is unknown where a force may be exerted, the targets may be associated with any of the tool parts in a regular or random pattern.

In an embodiment, the targets may be associated with any part of the hydrocarbon tool. For example, FIG. 12 illustrates an application of a target 1245 on the inner surface 1210 of the inner mandrel 1205. The targets may be associated with the hydrocarbon tool in locations that may be inaccessible without disassembly of the tool. In an embodiment requiring disassembly, the targets may be observed during redressing or repair of the tool. The choice of location of the targets may be based on considerations such as, without limitation, the location of expected wear, the type of target chosen, the operating conditions, and the frequency of monitoring required.

Several other embodiments may be used with the disclosed apparatus. For example, the hydrocarbon tool may be subject to trapped fluids within the tool, resulting in a pressure trap within the tool. In this embodiment, the targets may be associated with a hydrocarbon tool at or near a point where fluids may become trapped. Alternatively, the targets may be evenly distributed over parts of the tool subject to trapped fluid pressure in order to monitor the overall health state parameters of different part of the tool. In an alternative embodiment, the targets may be associated with a pressure test fixture. Such fixtures may experience fatigue over time due to repeated pressurizations. In this embodiment, the targets may be associated with a portion of the test fixture that may be observable by a sensor without disassembly. Such placement may allow the pressure test fixture to be monitored during and after use without requiring any downtime specifically for monitoring.

In an alternative embodiment, the targets may be associated with pumping equipment such as pump housings and manifolds used in drilling, cementing, or fracturing operations. In this embodiment, the targets may be monitored before, during, and after the procedure. As such, the targets may need to be placed at a wellbore servicing fluid pumping location capable of indicating the health state parameters while remaining observable during the procedure. Such placement may allow the fatigue, stress, and strain to be measured during the procedure.

A record may be created of the target positions and/or dimensions. As discussed above, the record may be maintained in a log external to the apparatus, or it may be maintained within the information contained in a 2D barcode symbol if the symbol is capable of containing information. For example, a target associated with an internal component of a packer may be a 2D barcode symbol containing information on its location on the hydrocarbon tool, its configuration and size, and its position relative to any other targets on the hydrocarbon tool.

A sensor may be utilized to observe the targets. The sensor may be any type of sensor compatible with the targets, as discussed above. In an embodiment in which the targets are associated with the internal and external components of a packer, the packer may require disassembly prior to observation with the sensor. For example, the sensor may be movable (e.g., may be capable of insertion into or through a conduit or tool through-bore such as a packer mandrel) and/or may be used during the redressing of the packer. A hand held sensor such as a laser scanner could be used to read a target such as a 2D barcode symbol associated with the packer. Alternatively, the sensor may be a camera that is a part of a machine vision system. This system may be used for real time measurements of the health state parameters of the hydrocarbon tool. For example, a camera that is part of a machine vision system may be used to observe a target such as a 2D barcode symbol on a pump housing during a fracturing procedure. An optional second sensor may be used to determine additional properties of the hydrocarbon tool useful in determining a health state parameter. For example, the second sensor may measure a distance between targets, an alternative distance measurement of the hydrocarbon tool, pressure within a system, or any other measurement useful in determining a health state parameter.

The sensor, the second sensor, or both may produce sensor outputs in response to an observation of the targets. An analysis device may be utilized to determine one or more health state parameters using the sensor output, the second sensor output, or both along with the record of the target positions and/or dimensions. A deformation of a hydrocarbon tool or a component of a hydrocarbon tool may be determined using the methods disclosed herein. For example, finite element analysis may be used to determine if a deformation has occurred at or near a target. In addition, a relative change in position and/or dimension of the plurality of targets may indicate that a deformation or a change in a health state parameter has occurred for the entire hydrocarbon tool or a portion of the hydrocarbon tool in between the individual targets.

The health state parameters determined using the apparatus disclosed herein may be used to determine if a hydrocarbon tool or a component of a hydrocarbon tool is suitable for its intended use. Should the health state parameters indicate that a hydrocarbon tool or component is no longer suitable for its intended use, the tool or component may be repaired or replaced prior to being utilized for further procedures.

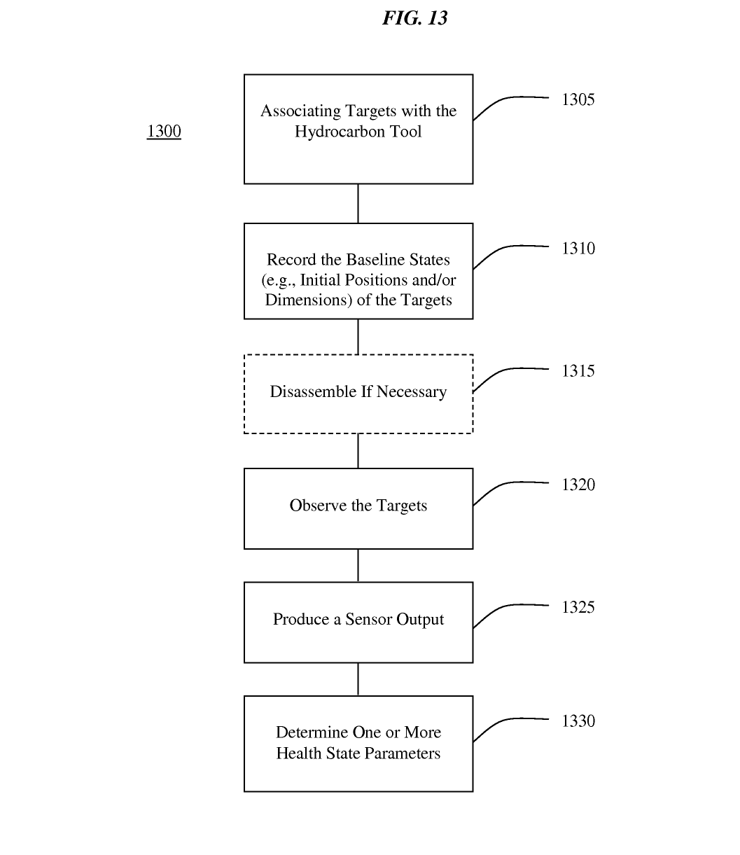

As shown in FIG. 13, the disclosed apparatus may be used to perform a method 1300 of monitoring the health state of a hydrocarbon tool. Initially, the targets may be associated with the hydrocarbon tool at block 1305. As noted above, the targets may be associated with the hydrocarbon tool at a location at or near an expected wear or deformation location. For example, a target may be associated with the hydrocarbon tool at or near a location that may be subject to trapped pressure. Alternatively, the target may be associated with the hydrocarbon tool at or near a location that experiences a mechanical force. The targets may be associated with the hydrocarbon tool at a location that may be observed by a sensor or at a location that requires disassembly in order to be observed.

The baseline/reference states of the targets (e.g., initial positions, orientations and/or dimensions of the targets) may be recorded at block 1310. The record may be used to indicate both the location and orientation of the targets associated with the hydrocarbon tools. As noted above, the record may be contained within the target if the target is capable of containing information. If targets are already associated with the hydrocarbon production equipment and a record exists, the method may initiate at block 1320.

As shown in FIG. 13, the targets associated with the connection may be observed at block 1315. The targets are observed using a sensor compatible with the plurality of targets. In an embodiment, the sensor may be a camera associated with a machine vision system and the targets may be 2D barcode symbols. The sensor may be capable of detecting a very small change in the targets associated with the connection, which may indicate a deformation. In an embodiment, a second sensor may also be utilized. For example, the second sensor may be use to determine the distance between the targets associated with the hydrocarbon tool. The second sensor readings may be used along with the observation of the targets to determine the health state parameters, including the stress and strain of the connection. In some embodiments, the hydrocarbon tools may require disassembly in order to observe the targets. In this embodiment, the observation of the targets may correspond to the time periods during which the hydrocarbon tools are being redressed or repaired. Alternatively, the targets may be observed during use in order to determine the health state parameters during use.

The sensor produces an output at block 1320 that may be used to determine the one or more health state parameters of the connection. In an embodiment with a second sensor, the second sensor may also produce a second sensor output. For example, the second sensor output may be the distance between the individual targets. The sensor output, the optional second sensor output, or both may then be used to produce one or more health state parameters in block 1325, as described in more detail herein.

In an embodiment, an analysis device such as a computer may be used to analyze the output received from the sensor, the second sensor, or both to produce the health state parameters, which may be used to determine the suitability of the hydrocarbon tool for its intended use. For example, the health state parameters may be used to indicate if a deformation of the hydrocarbon tool or a portion of the hydrocarbon tool has occurred. If a deformation has occurred, a fatigue measurement may be used to determine if the deformation has exceeded the thresholds and specifications for the hydrocarbon tool. If the tool or a component of the tool is no longer suitable for its intended use, the tool, the component, or both may be repaired or replaced prior to being returned to service. The monitoring of the hydrocarbon tool may be useful for determining, at the time of repair, which parts are suitable for use, and which ones should be replaced. In addition, the use of the disclosed method allows the health state of the hydrocarbon tool to be determined during use as well as at the time of repair.

In an embodiment in which the hydrocarbon tool is a packer or a zonal isolation device, the disclosed method may be used to monitor the health state parameters of the packer over its useful life. Specifically, the method may be used to monitor the packer elements and any housing or sleeve expansion. For example, a location at which an internal slip contacts a mandrel in a packer may be monitored for contraction or expansion after each use or during redressing of the packer. Housing and sleeve expansion from internally applied setting pressure may also be monitored. Such monitoring may allow the useful life of the tool to be extended as long as possible and the portion of the useful life consumed in a particular procedure to be determined.

In an embodiment in which the hydrocarbon tool is a pressure test fixture, the health state parameters of the fixture, including expansion of the fixture, may be monitored before, during, or after each use. Such monitoring of the health state parameters may allow a potential failure point to be determined, and the useful life extended as long as possible. The suitability of the pressure test fixture for its intended use, including the ability to withstand the expected testing pressures, may be determined prior to using the test fixture, thus ensuring the safety of the personnel performing the test.

In an embodiment in which the hydrocarbon tool is a pump housing, the health state parameters of the housing may be monitored before, during, and after each use. For example, the targets may be observed prior to a procedure in order to determine if a potential failure would occur during operation of the pump. If the health state parameters indicate that the pump housing is acceptable for its intended use, then the housing could be monitored during a procedure to ensure that the housing does not fall below any specification or threshold during use. For example, the pump housing could be monitored during a fracturing job, which typically results in high operating pressures that may cause fatigue in the housing. After the procedure is completed, the pump housing may be monitored to ensure that it is suitable for any future use. If the housing is not suitable for its intended use, the pump housing could be repaired or replaced prior to being returned to service. Such monitoring may also allow the portion of the useful life consumed during an operation to be determined. Such determination may assist in cost accounting for a given procedure.

In yet another embodiment, the disclosed apparatus and method may allow for the monitoring of hydrocarbon production equipment attachment points and brackets such as collars, couplings, flanges, extensions, etc. As noted above, the definition of hydrocarbon tools used in this description includes the attachment points associated with all of the tools described herein. An example of an attachment point may include a mounting bracket for a pump used to connect a pump to a trailer on which the pump is transported. Additional examples include, without limitation, the connection points for coiled tubing spools and pressure test fixtures.

The apparatus disclosed herein may be used to monitor the health state parameters of hydrocarbon production equipment connection points over their useful lives in order to determine when repair or replacement of parts or the entire connection point is necessary. In general, connection points may experience stress, strain, and fatigue due to a variety of causes. Common causes include vibration, cyclic forces associated with operation of the equipment, and cyclic forces associated with cycling tools and conduit into and out of the wellbore. As a failure of the connection point may generally render the equipment inoperable, it would be useful to be able to predict the timing and location of a failure of a connection point.

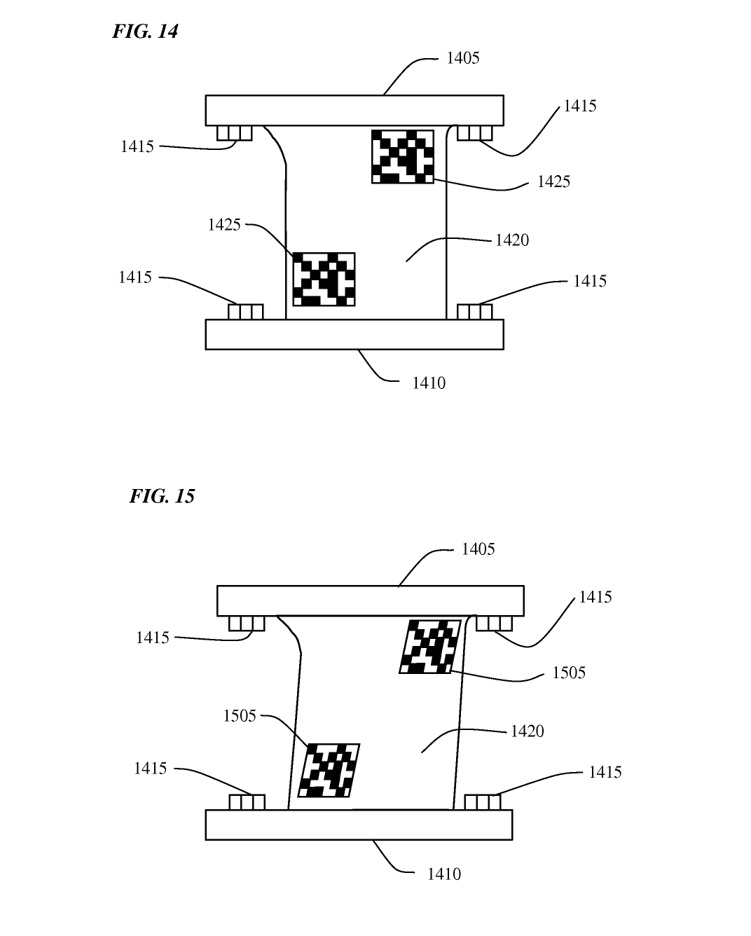

FIGS. 14 and 15 demonstrate an example of a connection point that may be monitored with the apparatus disclosed herein. A mounting bracket may comprise a top mounting plate 1405 connected to a mounting panel 1420. The lower portion of the bracket may be supported by a lower mounting plate 1410. The top mounting plate 1405 and the lower mounting plate 1410 may be connected to other equipment such as a trailer bed and a pump housing through the use of bolts 1415. In accordance with the present disclosure, a plurality of targets 1425 may be associated with the mounting bracket. While FIGS. 14 and 15 illustrate 2D barcodes, the targets may be any of the types previously discussed.

A record of the target positions and/or dimensions may be created. The record may be contained in an external source, or the record may be contained within the targets themselves if the targets are capable of communicating information.

A sensor may then be used to observe the targets. The sensor may be compatible with the targets and may be capable of determining the positions and/or dimensions of the targets, for example the spatial relationship of one or more nodes within the targets. FIG. 15 demonstrates a mounting bracket that has experienced fatigue. The wear on the bracket has resulted in targets 1505 that demonstrate a change in the spatial relationship between several nodes or the targets. The sensor may be capable of detecting this change. A second sensor may be used to detect additional properties of the mounting bracket. For example, a second sensor may optionally be used to determine the distance between the individual targets, for example, when the targets are not capable of being observed by a single sensor at once. Alternatively, the sensor may be capable of determining all of the properties necessary to determine the health state parameters. In addition, the sensor, the second sensor, or both may optionally include a sensor storage device for delaying the sensor output to the analysis device.

The apparatus may include an analysis device for determining one or more health state parameters. The analysis device may compare the record data (e.g., the target positions and/or dimensions) and the sensed data (e.g., sensor output, the second sensor output, or both) in determining the health state parameters. In this embodiment, the health state parameters may generally include those parameters necessary to determine fatigue and predict a potential failure point. Fatigue is generally determined by the stress and strain experienced on the connection point. Through the use of the mathematical techniques and equations described above, one skilled in the art could determine with aid of the present disclosure the health state parameter values using an analysis device with the sensor output and the record data (e.g., target positions, dimensions and/or configurations). Such information would indicate when a particular component of the connection point or the entire connection point should be repaired or replaced. Further, continuous monitoring would allow an approaching failure point to be identified and avoided, thus preventing unexpected downtime for repairs.

Returning to FIG. 5, the apparatus disclosed herein may be used to perform a method 500 of monitoring the health state of a hydrocarbon production equipment connection point. The method is the same as previously described. In this embodiment, the one or more health state parameters produced through the use of the method may be used to predict a potential failure point. Monitoring throughout the useful life of the connection point may allow the equipment's useful life to be extended as long as possible.

In various embodiments disclosed herein, the hydrocarbon production equipment and servicing methods disclosed herein may be used in a variety of hydrocarbon production and wellbore services. Natural resources such as gas, oil, and water residing in a subterranean formation or zone are usually recovered by drilling a wellbore down to the subterranean formation while circulating a drilling fluid in the wellbore. After terminating the circulation of the drilling fluid, a string of pipe, e.g., casing, is run in the wellbore. The drilling fluid is then usually circulated downward through the interior of the pipe and upward through the annulus, which is located between the exterior of the pipe and the walls of the wellbore. Next, primary cementing is typically performed whereby cement slurry is placed in the annulus and permitted to set into a hard mass (i.e., sheath) to thereby attach the string of pipe to the walls of the wellbore and seal the annulus. Subsequent secondary cementing operations may also be performed.

Wellbore servicing as used herein commonly employs a variety of compositions generally termed wellbore “servicing fluids.” As used herein, a “servicing fluid” refers to a fluid used to drill, complete, work over, fracture, repair, or in any way prepare a wellbore for the recovery of materials residing in a subterranean formation penetrated by the wellbore. Examples of servicing fluids include, but are not limited to cement slurries, drilling fluids or muds, spacer fluids, fracturing fluids or completion fluids, all of which are well known in the art. The servicing fluid is for use in a wellbore that penetrates a subterranean formation. It is to be understood that “subterranean formation” encompasses both areas below exposed earth and areas below earth covered by water such as ocean or fresh water.

Wellbore servicing may be conducted to achieve a variety of user-desired results. For example, wellbore servicing may be carried out to prevent the loss of aqueous or non-aqueous drilling fluids into lost circulation zones such as voids, vugular zones, and natural or induced fractures while drilling. In an embodiment, a servicing fluid is placed into a wellbore as a single stream and activated by downhole conditions to form a barrier that substantially seals lost circulation zones. In such an embodiment, the servicing fluid may be placed downhole through the drill bit forming a non-flowing, intact mass inside the lost circulation zone which plugs the zone and inhibits loss of subsequently pumped drilling fluid, allowing for further drilling. For example, the servicing fluid may form a mass that plugs the zone at elevated temperatures, such as those found at higher depths within a wellbore. Methods for introducing compositions into a wellbore to seal subterranean zones are described in U.S. Pat. Nos. 5,913,364; 6,167,967; and 6,258,757, each of which is incorporated by reference herein in its entirety.

In an embodiment, wellbore servicing may comprise well completion operations such as cementing operations. In such embodiments, a servicing fluid may be placed into an annulus of the wellbore and allowed to set such that it isolates the subterranean formation from a different portion of the wellbore. The set servicing fluid thus forms a barrier that prevents fluids in that subterranean formation from migrating into other subterranean formations. In an embodiment, the wellbore in which the servicing fluid is positioned belongs to a multilateral wellbore configuration. It is to be understood that a multilateral wellbore configuration includes at least two principal wellbores connected by one or more ancillary wellbores.

In an embodiment, wellbore servicing may comprise secondary cementing, often referred to as squeeze cementing. In such an embodiment, a servicing fluid may be strategically positioned in the wellbore to plug a void or crack in a conduit, to plug a void or crack in a hardened sealant (e.g., cement sheath) residing in the annulus, to plug a relatively small opening known as a microannulus between the hardened sealant and the conduit, and so forth. Various wellbore servicing procedures are described in U.S. Pat. Nos. 5,346,012 and 5,588,488, which are incorporated by reference herein in their entirety.

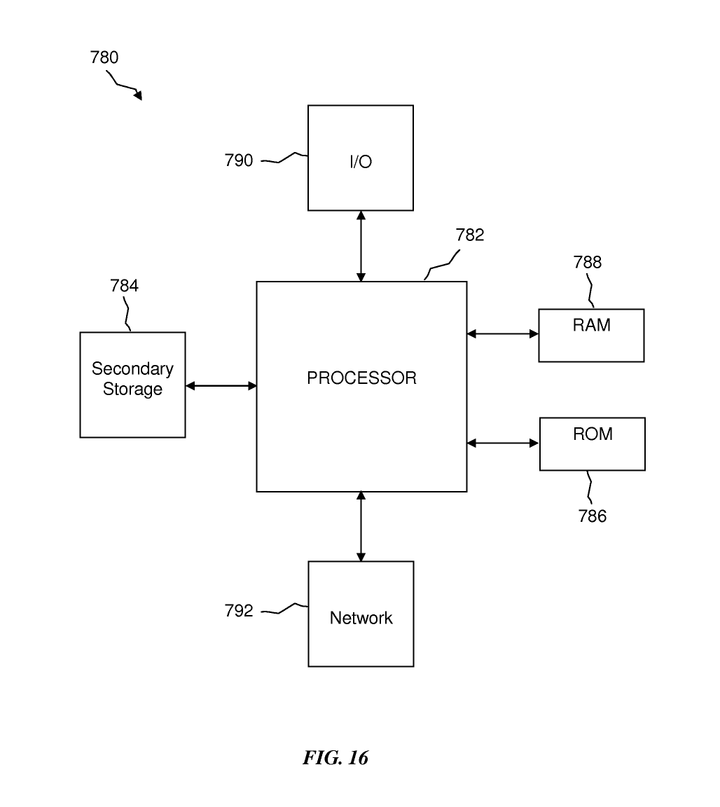

Various of the components described herein, including but not limited to sensor 140, analysis device 160, record 130, and various data storage devices, may be embodied in software and/or one or more elements of a general computing device, as shown in FIG. 16, associated with the hydrocarbon production equipment and/or services. For example, portions of the system described above may be implemented on any general-purpose computer with sufficient processing power, memory resources, and network throughput capability to handle the necessary workload placed upon it. As with mobile devices developed for the consumer electronics market, one skilled in the art will readily appreciate the benefits of leveraging readily available general purpose computer systems by adopting them for use as described herein. FIG. 16 illustrates a typical, general-purpose computer system suitable for implementing one or more embodiments disclosed herein. The computer system 780 includes a processor 782 (which may be referred to as a central processor unit or CPU) that is in communication with memory devices including secondary storage 784, read only memory (ROM) 786, random access memory (RAM) 788, input/output (1/0) devices 790, and network connectivity devices 792. The processor may be implemented as one or more CPU chips.

The secondary storage 784 is typically comprised of one or more disk drives or tape drives and is used for non-volatile storage of data and as an over-flow data storage device if RAM 788 is not large enough to hold all working data. Secondary storage 784 may be used to store programs which are loaded into RAM 788 when such programs are selected for execution. The ROM 786 is used to store instructions and perhaps data which are read during program execution. ROM 786 is a non-volatile memory device which typically has a small memory capacity relative to the larger memory capacity of secondary storage. The RAM 788 is used to store volatile data and perhaps to store instructions. Access to both ROM 786 and RAM 788 is typically faster than to secondary storage 784.

I/O devices 790 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 792 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as OFDMA, global system for mobile communications (GSM), and/or code division multiple access (CDMA) radio transceiver cards, and other well-known network devices. The network connectivity devices 792 may provide radio transceiver cards that promote WiMAX, 3.5 G, and/or 4 G wireless communications. These network connectivity devices 792 may enable the processor 782 to communicate with an Internet or one or more intranets. With such a network connection, it is contemplated that the processor 782 might receive information from the network, or might output information to the network in the course of performing the above-described method steps. Such information, which is often represented as a sequence of instructions to be executed using processor 782, may be received from and outputted to the network, for example, in the form of a computer data signal embodied in a carrier wave.

Such information, which may include data or instructions to be executed using processor 782 for example, may be received from and outputted to the network, for example, in the form of a computer data baseband signal or signal embodied in a carrier wave. The baseband signal or signal embodied in the carrier wave generated by the network connectivity devices 792 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 782 executes instructions, codes, computer programs, scripts which it accesses from hard disk, floppy disk, optical disk (these various disk based systems may all be considered secondary storage 784), ROM 786, RAM 788, or the network connectivity devices 792.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What we claim is:

1. An apparatus for determining a health state of hydrocarbon production equipment comprising:
one or more targets associated with hydrocarbon production equipment;
a record indicating a baseline state of the of the one or more targets;
a sensor capable of observing the one or more targets, wherein the sensor is compatible with the one or more targets and produces a sensor output comprising a current state of the one or more targets; and
an analysis device, wherein the analysis device receives the record and the sensor output, compares the baseline state of the target to the current state of the target, and produces one or more health state parameters associated with the hydrocarbon production equipment.

2. The apparatus of claim 1 wherein the hydrocarbon production equipment comprises one or more of a production conduit, transmission equipment, hydrocarbon tools, an equipment attachment point, or combinations thereof.

3. The apparatus of claim 1 wherein the target state comprises one or more of a dimension, position, location, characteristic, orientation, or spatial relationship of a target.

4. The apparatus of claim 1 wherein the health state parameter comprises one or more health state parameters comprise a localized stress reading near one or more targets, a stress reading for the hydrocarbon production equipment, a localized strain measurement near one or more targets, an overall strain measurement for the hydrocarbon production equipment, a localized fatigue measurement near one or more targets, an overall fatigue measurement for the hydrocarbon production equipment, an elongation measurement of the hydrocarbon production equipment, the degree of ovality for cylindrical hydrocarbon production equipment, the curvature of a surface of the hydrocarbon production equipment, the flexural strength of the hydrocarbon production equipment, a localized flexural strength near one or more targets, and combinations thereof.

5. The apparatus of claim 1 wherein the targets are selected from the group consisting of 1D barcode symbols, 2D barcode symbols, data matrix symbols (DMS), 3D barcode symbols, Bumpy Barcodes, 3-DI symbols, ArrayTag symbols, Aztec Code symbols, Small Aztec Code symbols, Codablock symbols, Code 1 symbols, Code 16K symbols, Code 49 symbols, CP Code symbols, DataGlyphs, Datastrip Code symbols, Dot Code A symbols, hueCode symbols, Intacta.Code symbols, MaxiCode symbols, PDF 417 symbols, Micro PDF417 symbols, QR Code symbols, SmartCode symbols, Snowflake Code symbols, SuperCode symbols, Ultracode symbols, identified surface markings, identified subsurface markings, generated subsurface markings, a symbol capable of defining a Symbolic Strain Rosette (“SSR”), and combinations thereof.

6. The apparatus of claim 1 wherein the one or more targets are associated with the hydrocarbon production equipment using one or more of removing material from the equipment, adding material to the equipment, or changing the nature of the material in the equipment.

7. The apparatus of claim 1 wherein a plurality of targets are placed at regular intervals along the hydrocarbon production equipment.

8. The apparatus of claim 1 wherein a plurality of targets contain unique identifiers.

9. The apparatus of claim 1 wherein a plurality of targets are placed in a spiral pattern, a linear pattern, or a random pattern.

10. The apparatus of claim 1 wherein the sensor comprises one or more of a camera, a machine vision system, a portion of a machine vision system, an optical sensor, or combinations thereof.

11. The apparatus of claim 1 wherein the sensor operates in a portion of at least one of the electromagnetic, acoustic, or magnetic spectra.

12. The apparatus of claim 1 further comprising a storage device for storing the sensor output.

13. The apparatus of claim 1 further comprising:
a second sensor providing a second sensor output to the analysis device, wherein the second sensor output comprises one or more of a length along the hydrocarbon production equipment, a load carried by the hydrocarbon production equipment, a relative radial position of the sensor with respect to the hydrocarbon production equipment, a relative longitudinal position of the sensor with respect to the hydrocarbon production equipment, a rate of movement of the sensor, a rate of movement of the hydrocarbon production equipment, or combinations thereof.

14. The apparatus of claim 1 wherein a plurality of targets are associated with the hydrocarbon production equipment such that a higher density of targets exists in the proximity of hydrocarbon production equipment connection, a hydrocarbon production zone, or joint locations.

15. The apparatus of claim 1 wherein the record is contained in one or more of the target, a memory device associated with the analysis device, an external log, or combinations thereof.

16. A method for determining a health state of hydrocarbon production equipment comprising:
associating one or more targets with hydrocarbon production equipment;
recording a baseline state of the one or more targets in a record;
observing the one or more targets with a sensor and providing a sensor output comprising a current state of the targets; and
comparing the current state of the one or more targets to the baseline state of the one or more targets to provide one or more health state parameters associated with the hydrocarbon production equipment.

17. The method of claim 16 wherein the hydrocarbon production equipment comprises one or more of a production conduit, transmission equipment, hydrocarbon tools, an equipment attachment point, or combinations thereof.

18. The method of claim 16 wherein the target state comprises one or more of a dimension, position, location, characteristic, orientation, or spatial relationship of a target.

19. The method of claim 16 wherein the health state parameter comprises one or more health state parameters comprise a localized stress reading near one or more targets, a stress reading for the hydrocarbon production equipment, a localized strain measurement near one or more targets, an overall strain measurement for the hydrocarbon production equipment, a localized fatigue measurement near one or more targets, an overall fatigue measurement for the hydrocarbon production equipment, an elongation measurement of the hydrocarbon production equipment, the degree of ovality for cylindrical hydrocarbon production equipment, the curvature of a surface of the hydrocarbon production equipment, the flexural strength of the hydrocarbon production equipment, a localized flexural strength near one or more targets, and combinations thereof.

20. The method of claim 16 wherein the one or more targets are associated with the hydrocarbon production equipment using one or more of removing material from the equipment, adding material to the equipment, or changing the nature of the material in the equipment.

21. The method of claim 16 wherein the record is contained in one or more of the target, a memory device associated with the analysis device, an external log, or combinations thereof.

22. The method of claim 16 wherein the sensor operates in a portion of at least one of the electromagnetic, acoustic, or magnetic spectra.

23. The method of claim 16 wherein the sensor comprises one or more of a camera, a machine vision system, a portion of a machine vision system, or combinations thereof.

24. The method of claim 16 further comprising:
observing the hydrocarbon production equipment with a second sensor and providing a second sensor output that is used in determining one or more of the health state parameters, the second sensor output comprising one or more of a length measurement along the hydrocarbon production equipment, a measurement of the load carried by the hydrocarbon production equipment, a relative radial position of the sensor with respect to the hydrocarbon production equipment, a relative longitudinal position of the sensor with respect to the hydrocarbon production equipment, a rate of movement of the sensor, a rate of movement of the hydrocarbon production equipment, or combinations thereof.

25. The method of claim 16 further comprising:
predicting an approaching failure point for the hydrocarbon production equipment or a section of the hydrocarbon production equipment based on the one or more health state parameters.
